(19) United States
(12) Patent Application Publication
(10) Pub. No.: US 2008/0170766 A1
(43) Pub. Date: Jul. 17, 2008

(54) METHOD AND SYSTEM FOR DETECTING CANCER REGIONS IN TISSUE IMAGES

(76) Inventor: Spyros A. Yfantis, Carlstadt, NJ (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/967,560

(22) Filed: Dec. 31, 2007

Related U.S. Application Data
(60) Provisional application No. 60/928,341, filed on May 8, 2007.
(60) Provisional application No. 60/880,310, filed on Jan. 12, 2007.

(51) Int. Cl. G06K 9/00

(52) U.S. Cl. 382/128

(57) ABSTRACT

A pixel of an image is classified between a first kind and a second kind by centering a sample mask on the pixel and applying each of a population of R given basis functions to the mask pixels to generate, for each basis function, a bucket of values. A probability density function is estimated for each of the bucket of values. Each of the R probability density functions is transformed to a single valued result, to generate an R-dimensional sample classification vector. The R-dimensional sample classification vector is classified against a R-dimensional first centroid vector and a R-dimensional second centroid vector, each of centroid vectors constructed in a previous training of applying the same population of R given basis functions to pixels known as being the first kind and to pixels known as being the second kind. Optionally, pixels may be conditionally classified and then finally classified based on subsequent classification of neighbor pixels.

### CROSS-REFERENCE TO RELATED APPLICATIONS

This application claims priority to U.S. Provisional Application Ser. No. 60/880,310, filed Jan. 12, 2007, which is hereby incorporated by reference.

### FIELD OF THE INVENTION

Embodiments of the invention pertain to diagnostic imaging of tissue and, in some embodiments, to mapping pixel regions to an N-dimensional space and recognizing certain tissue characteristics based on the mapping.

### BACKGROUND OF THE INVENTION

Even though new methods for treatment and new strategies for detection have become available, prostate cancer remains the second most common cancer that kills men in the United States. Only lung cancer causes a higher number of deaths. The numbers are telling. More than 230,000 new cases of prostate cancer were diagnosed in the U.S. during 2005.

The number of new cases alone is not a complete measure of the problem. Prostate cancer is a progressive disease and, generally, the earlier the stage of its progress when first detected the better the realistic treatment options and the longer the life expectancy. Unfortunately, many cases are detected late, after the prostate cancer cells have metastasized or otherwise escaped the confine of the prostate.

Therefore, the earlier the detection the better the patient's chances for the cancer being halted, and the better the patient's chances for a reasonable life and a reasonable life expectancy.

However, current prostate cancer detection technologies and methods are clearly inadequate, as evidenced by the still significant number of cases detected at a later stage of the cancer, where treatment options are more limited and the prognosis may be statistically unfavorable.

Existing prostate cancer detection methods can be roughly grouped into two general categories, each having respectively different objectives and priorities regarding accuracy, convenience and cost. The first category can be referenced as “screening methods,” and the second category can be referenced as “confirmation” or “evaluation” methods. This is a coarse categorization, having some overlaps, but will suffice to demonstrate shortcoming of the current methods.

Regarding screening methods, generally desired objectives are reasonable accuracy or error rate, low cost, low risk of injury and low inconvenience and discomfort for the patient.

Regarding confirmation or evaluation methods, generally desired objectives include higher classification accuracy (or lower error rate), higher measurement accuracy (e.g., size and number of tumors, and progression on the Gleason scale), generally with less concern as to cost and, unfortunately for the patient, less priority of minimizing discomfort.

The two most common current screening methods are: (1) the PSA test and (2) a urologist performing digital rectal exam, and both of these methods have a significant error rate. There are significant differences in the published opinions of different reputable health care professionals as to the accuracy and usefulness of PSA. Digital rectal examination has a significant false negative rate because, at least in part, many prostate cancer cases may have already progressed before being detected, or being detectable by even the most skilled urologist. The current screening methods are therefore, at best, in need of significant improvement.

The current most accepted confirmation or evaluation method is biopsy of the prostate. Biopsy of the prostate may include transrectal ultrasound, (TRUS) for visual guidance, and insertion of a spring loaded needle to remove small tissue samples from the prostate. The samples are then sent to a laboratory for pathological analysis and confirmation of a diagnosis. Generally, ten to twelve biopsy samples are removed during the procedure. Biopsy of the prostate, although one currently essential tool in the battle against prostate cancer, is invasive, is generally considered to be inconvenient, is not error free, and is expensive.

Ultrasound, particularly TRUS has been considered as a screening method. TRUS has known potential benefits. One is that the signal is non-radioactive and contains no harmful material. Another is that the equipment is fairly inexpensive and relatively easy to use.

However, although there have been attempts toward improvement, current TRUS systems are known as exhibiting what is currently considered insufficient image quality for even the most skilled urologist to accurately detect cancerous regions early enough to be of practical use.

One attempt at improvement of ultrasound is described in U.S. Pat. No. 5,224,175, issued Jun. 29, 1993 to Gouge et al. (“the '175 patent”). Although described as reducing speckle and describing some automation of detection, there is remaining significant need for, and a potential for very substantial benefits from still further improvement in detection accuracy and sensitivity. Embodiments according to the present invention may provide such improvement, such that TRUS and other ultrasound scanning may become a new and better screening method, and potentially a screening of choice for prostate and perhaps many other cancers.

### SUMMARY OF THE INVENTION

The present invention provides significantly improved automatic pixel classification between a pixel representing a tissue having a given condition, such as cancer and not having the given condition.

Embodiments of the present invention provide significantly higher detection rate, and significantly lower classification error than known prior art automated ultrasound image feature detection.

Embodiments of the present invention employ new basis functions, in novel combinations and arrangements, to extract characterizing information from image pixels and pixel regions that is additional to information extracted by prior art automated detection.

Embodiments of the present invention generate classification vectors by applying to training images having known pixel types the same basis functions that will be used to classify unknown pixels, to generate classification vectors optimized for detection sensitivity and minimal error.

Embodiments of the present invention extract further characterizing information, effectively filtering speckles and artifacts, while improving sensitivity, by estimating a probability density function for the results obtained from applying the basis functions to the subject pixels.

Embodiments of the present invention generate classification vectors by transforming the estimated probability density function obtained from applying the basis functions to pixel regions into vector form, so as to better extract and compare characterizing information.

Embodiments of the present invention further include a multiple pass classification, providing a conditional classification by an initial pass, subject to confirmation by classifying neighbors on subsequent passes. These embodiments of the invention provide significant benefit of improved detection sensitivity, reducing false negatives, without substantial concurrent increase in false positives. These benefits and improvements may reduce the unfortunate instances of late stage initial discovery of prostate cancer.

### BRIEF DESCRIPTION OF THE DRAWINGS

FIG. 1 is a high level functional block diagram representing one example system for practicing some embodiments of the invention;

FIG. 2 shows one example ultrasound image in which certain features and characteristics may be recognized according to one or more embodiments;

FIG. 3 is a more detailed functional block diagram representing one example system according to, for example FIG. 1, for practicing some embodiments of the invention;

FIG. 4 shows one example of one circular sample mask according to one embodiment;

FIG. 5 graphically illustrates one computer-calculated histogram reflecting a probability density function of calculated of autocorrelation products of pixels spaced at lag-1 along the labeled x-direction of the FIG. 4 sample mask, for pixels of an image area corresponding to non-cancerous prostate tissue;

FIG. 6 graphically illustrates one computer-calculated histogram reflecting a probability density function of the value of autocorrelation products of pixels spaced at lag-1 along the labeled x-direction of the FIG. 4 sample mask, for pixels of an image area corresponding to cancerous prostate tissue;

FIGS. 7-10 graphically illustrate respective computer-calculated histogram estimates of a probability density function of calculated values approximating, respectively, a first partial derivative of pixel magnitudes along the labeled X-direction, a first partial derivative of pixel magnitudes along the labeled Y-direction, a first partial derivative of pixel magnitudes along the labeled DG1 diagonal direction, and a first partial derivative of pixel magnitudes along the labeled DG2 diagonal direction of the FIG. 4 sample mask, for pixels of an image area corresponding to non-cancerous prostate tissue;

FIGS. 11-14 graphically illustrate respective computer-calculated histogram estimates of a probability density function of calculated values approximating, respectively, a first partial derivative of pixel magnitudes along the labeled X-direction, a first partial derivative of pixel magnitudes along the labeled Y-direction, a first partial derivative of pixel magnitudes along the labeled DG1 diagonal direction, and a first partial derivative of pixel magnitudes along the labeled DG2 diagonal direction of the FIG. 4 sample mask, for pixels of an image area corresponding to cancerous prostate tissue;

FIGS. 15-18 graphically illustrate respective computer-calculated histogram estimates of a probability density function of calculated values approximating, respectively, a second partial derivative of pixel magnitudes along the labeled X-direction, a second partial derivative of pixel magnitudes along the labeled Y-direction, a second partial derivative of pixel magnitudes along the labeled DG1 diagonal direction, and a second partial derivative of pixel magnitudes along the labeled DG2 diagonal direction of the FIG. 4 sample mask, for pixels of an image area corresponding to non-cancerous prostate tissue;

FIGS. 19-22 graphically illustrate respective computer-calculated histogram estimates of a probability density function of calculated values approximating, respectively, a second partial derivative of pixel magnitudes along the labeled X-direction, a second partial derivative of pixel magnitudes along the labeled Y-direction, a second partial derivative of pixel magnitudes along the labeled DG1 diagonal direction, and a second partial derivative of pixel magnitudes along the labeled DG2 diagonal direction of the FIG. 4 sample mask, for pixels of an image area corresponding to cancerous prostate tissue;

FIGS. 23-25 graphically illustrate respective computer-calculated histogram estimates of a probability density function of calculated values approximating, respectively, the value of autocorrelation products of pixels spaced at lag-1 along the labeled Y-direction, at lag-1 along the labeled DG1 diagonal direction, and at lag-1 along the labeled DG2 diagonal direction of the FIG. 4 sample mask, for pixels of an image area corresponding to non-cancerous prostate tissue;

FIGS. 26-28 graphically illustrate respective computer-calculated histogram estimates of a probability density function of calculated values approximating, respectively, the value of autocorrelation products of pixels spaced at lag-1 along the labeled Y-direction, at lag-1 along the labeled DG1 diagonal direction, and at lag-1 along the labeled DG2 diagonal direction of the FIG. 4 sample mask, for pixels of an image area corresponding to cancerous prostate tissue;

FIGS. 29-32 graphically illustrate respective computer-calculated histogram estimates of a probability density function of calculated values approximating, respectively, the value of autocorrelation products of pixels spaced at lag-2 along the labeled X-direction, at lag-2 along the labeled Y-direction, at lag-2 along the labeled DG1 diagonal direction, and at lag-2 along the labeled DG2 diagonal direction of the FIG. 4 sample mask, for pixels of an image area corresponding to non-cancerous prostate tissue;

FIGS. 33-36 graphically illustrate respective computer-calculated histogram estimates of a probability density function of calculated values approximating, respectively, the value of autocorrelation products of pixels spaced at lag-2 along the labeled X-direction, along the labeled Y-direction, the labeled DG1 diagonal direction, and the labeled DG2 diagonal direction of the FIG. 4 sample mask, for pixels of an image area corresponding to cancerous prostate tissue;

FIGS. 37-40 graphically illustrate respective computer-calculated histogram estimates of a probability density function of calculated values approximating, respectively, the value of autocorrelation products of pixels spaced at lag-3 along the labeled X-direction, along the labeled Y-direction, the labeled DG1 diagonal direction, and the labeled DG2 diagonal direction of the FIG. 4 sample mask, for pixels of an image area corresponding to non-cancerous prostate tissue;

FIGS. 41-44 graphically illustrate respective computer-calculated histogram estimates of a probability density function of calculated values approximating, respectively, the value of autocorrelation products of pixels spaced at lag-3 along the labeled X-direction, along the labeled Y-direction, the labeled DG1 diagonal direction, and the labeled DG2 diagonal direction of the FIG. 4 sample mask, for pixels of an image area corresponding to cancerous prostate tissue;

FIG. 45 graphically illustrates one computer-calculated histogram reflecting a probability density function of each pixel's deviation from an average magnitude over the sample mask, for pixels of an image area corresponding to non-cancerous prostate tissue;

FIG. 46 graphically illustrates one computer-calculated histogram reflecting a probability density function of each pixel's deviation from an average magnitude over the sample mask, for pixels of an image area corresponding to cancerous prostate tissue;

FIG. 47 shows one high level functional flow diagram representing one illustrative method practicing some embodiments of the invention;

FIG. 48 shows one high level functional flow diagram representing one illustrative implementation of the FIG. 46 baseline training block; and

FIG. 49 graphically illustrates one arrangement for a display of a classification result provided by one embodiment.

### DETAILED DESCRIPTION OF ILLUSTRATIVE EMBODIMENTS

The following detailed description refers to accompanying drawings that form part of this description. The description and its drawings, though, show only examples of systems and methods embodying the invention and with certain illustrative implementations. Many alternative implementations, configurations and arrangements can be readily identified by persons of ordinary skill in the pertinent arts upon reading this description.

It will be understood that like numerals appearing in different ones of the accompanying drawings, regardless of being described as the same or different embodiments of the invention, reference functional blocks or structures that are, or may be, identical or substantially identical between the different drawings.

Unless otherwise stated or clear from the description, the accompanying drawings are not necessarily drawn to represent any scale of hardware, functional importance, or relative performance of depicted blocks.

Unless otherwise stated or clear from the description, different illustrative examples showing different structures or arrangements are not necessarily mutually exclusive. For example, a feature or aspect described in reference to one embodiment may, within the scope of the appended claims, be practiced in combination with other embodiments. Therefore, instances of the phrase “in one embodiment” do not necessarily refer to the same embodiment.

Example systems and methods embodying the invention are described in reference to subject input images generated by ultrasound. Ultrasound, however, is only one example application. Systems and methods may embody and practice the invention in relation to images representing other absorption and echo characteristics such as, for example, X-ray imaging.

Example systems and methods are described in reference to example to human male prostate imaging. However, human male prostate imaging is only one illustrative example and is not intended as any limitation on the scope of systems and methods that may embody the invention. It is contemplated, and will be readily understood by persons of ordinary skill in the pertinent art that various systems and methods may embody and practice the invention in relation to other human tissue, non-human tissue, and various inanimate materials and structures.

General embodiments may operate on N×M pixel images. The N and M may be, but are not necessarily equal, and the N×M pixel image may be, but is not necessarily rectangular. Contemplated embodiments include, but are not limited to, radial shaped images known in the conventional TRUS art.

Embodiments may operate on what is known in the pertinent art as “raw” images, meaning no image filtering performed prior to practicing the present invention. Alternatively, embodiments may be combined with conventional image filtering such as, for example, smoothing, compression, brightening and darkening. Embodiments may receive input analog-to-digital (A/D) sampled data representing a sequence of frames of an image, such as a sequence of frames representing a conventional TRUS image as displayed on a conventional display of a conventional TRUS scanner.

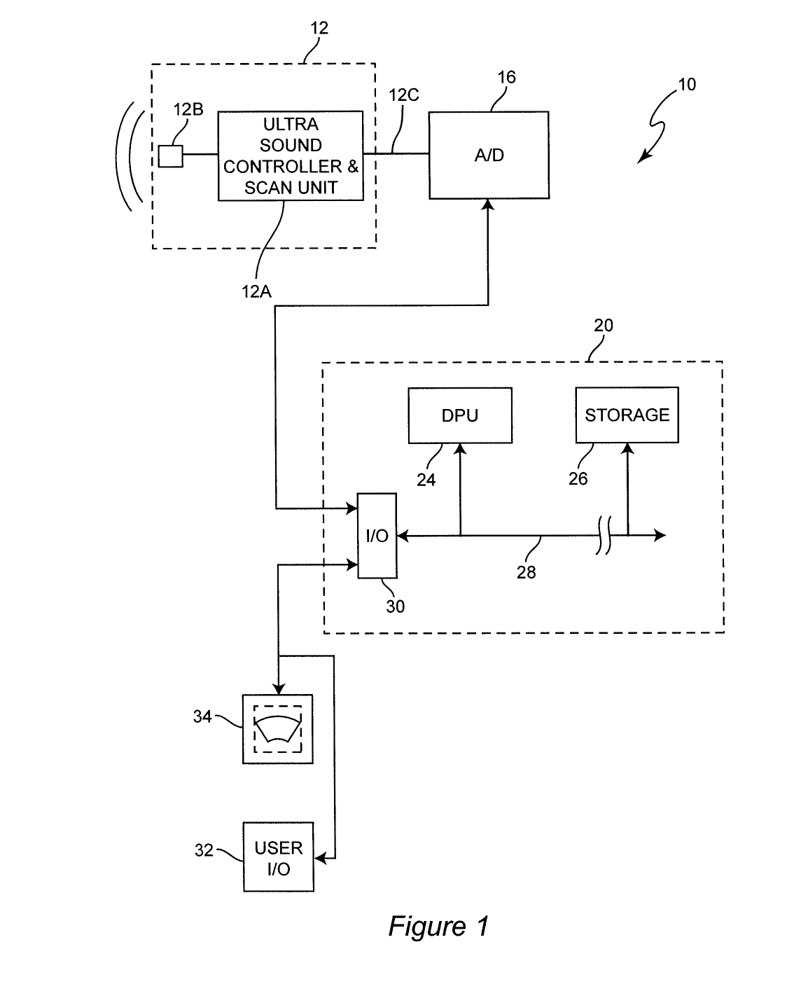

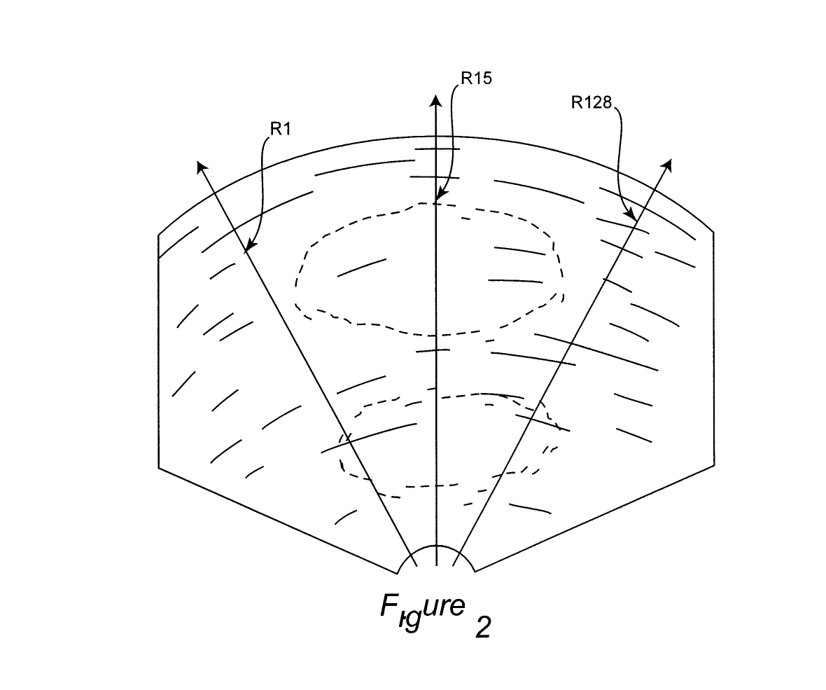

FIG. 1 shows one illustrative example system 10 to practice embodiments of the invention. The example system 10 is shown in as functional block diagram, segregated into functional blocks to facilitate a clear understanding of described example operations. The particular FIG. 1 segregation of labeled blocks and their graphical arrangement is only one example representation of one example recognition system having embodiments of the invention, and is not a limitation as to systems that may embody the invention. The labeled blocks are not necessarily representative of separate or individual hardware units, and the arrangement of the labeled blocks does not necessarily represent any hardware arrangement. Certain illustrative example implementations of certain blocks and combinations of blocks will be described in greater detail. The example implementations, however, may be unnecessary to practice the invention, and persons of ordinary skill in the pertinent arts will readily identify various alternative implementations based on this disclosure.

Referring to FIG. 1, the example system 10 includes an ultrasound generator/receiver labeled generally as 12, having an ultrasound signal control processor 12A connected to a transmitter/receiver transducer unit 12B and a having a signal output 12C. The ultrasound generator/receiver 12 may be a conventional medical ultrasound scanner such as, for example, a B&K Medical Systems Model 2202 or any of a wide range of equivalent units and system available from other vendors well known to persons of ordinary skill in the pertinent arts. The transmitter/receiver transducer unit 12B may be, for example, a B & K Model 1850 transrectal probe, or may be any of the various equivalents available from other vendors well known to persons of ordinary skill.

Selection of the power, frequency and pulse rate of the ultrasound signal may be in accordance with conventional ultrasound practice. On example is a frequency in the range of approximately 3.5 MHz to approximately 12 MHz, and a pulse repetition or frame rate of approximately 600 to approximately 800 frames per second. Another example frequency range is up to approximately 80 MHz. As known to persons skilled in the pertinent arts, depth of penetration is much less at higher frequencies, but resolution is higher. Based on the present disclosure, a person of ordinary skill in the pertinent arts may identify applications where frequencies up to, for example, 80 MHz may be preferred.

With continuing reference to FIG. 1, the example system 10 includes an analog/digital (A/D) sampler and frame buffer 16 connecting to a data processing resource labeled generally as 20. It will be understood that the ultrasound generator/receiver 12, the A/D sampler and frame buffer 16, and the data processing resource 20 may be implemented as one integrated system or may be implemented as any architecture and arrangement of hardware units.

Referring to FIG. 1, the depicted data processing resource 20 includes a data processing unit 24 for performing instructions according to machine-executable instructions, a data storage 26 for storing image data (not shown in FIG. 1) and for storing machine executable instructions (not shown in FIG. 1), and having an internal data/control bus 28, and a data/control interface 30 connecting the internal data/control bus 28 to the A/D sampler and frame buffer 16 and to a user data input unit 32, and a display 34.

The data storage 26 may include, for example, any of the various combinations and arrangements of machine-readable data storage known in the conventional arts including, for example, a solid-state random access memory (RAM), magnetic disk devices and/or optical disk devices.

The data processing resource 20 may be implemented by a conventional programmable personal computer (PC) having one or more data processing resources, such as an Intel™ Core™ or AMD™ Athlon™ processor unit or processor board, implementing the data processing unit 24, and having any standard, conventional PC data storage 26, internal data/control bus 28 and data/control interface 30. The only selection factor for choosing the PC (or any other implementation of the data processing resource 20) that is specific to the invention is the computational burden of the described feature extraction and classification operations, which is readily ascertained by a person of ordinary skill in the pertinent art based on this disclosure.

With continuing reference to FIG. 1, the display 34 is preferably, but is not necessarily, a red-green-blue (RGB) or equivalent color display. As will be understood from this disclosure, embodiments of the present invention may include highlighting of pixels that are identified by the disclosed classification features as associated with a particular class such as, for example, cancerous tissue. A color display 34 may provide various options for such pixel highlighting. Whether black and white or color, the display 34 may be a cathode ray tube (CRT), liquid crystal display (LCD), projection unit or equivalent, having a practical viewing size and preferably having a resolution of, for example, 600×800 pixels or higher.

The user data input device 32 may, for example, be a keyboard (not shown), computer mouse (not shown) that is arranged through machine-executable instructions (not shown) in the data processing resource 20 to operate in cooperation with the display 34 or another display (not shown). Alternatively, the user data input unit 32 may be included as a touch screen feature (not shown) integrated with the display 34 or with another display (not shown).

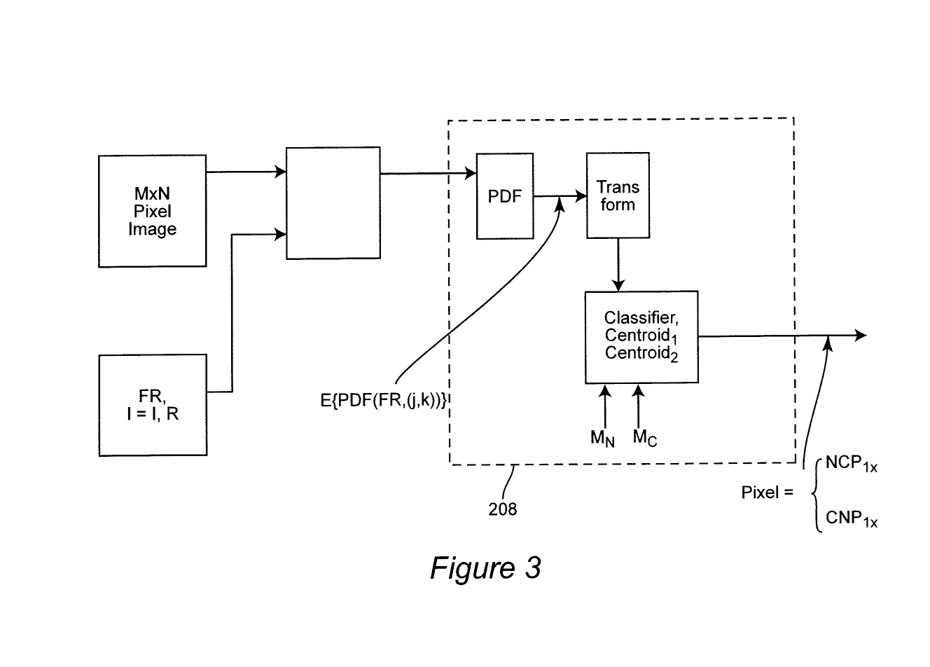

FIG. 3 shows, in greater detail, one example pixel classification system 200 according to one embodiment, which may be configured and installed on the FIG. 1 data processing resource 20.

Referring to FIG. 3, the depicted example pixel classification system 200 comprises a plurality 202 of R specific basis functions, referenced generically as FR and specifically as FRᵢ, i=1 to R, at least one N×M pixel frame of image data, labeled 204, formed of pixels referenced individually as j, k, where j=1 to N and k=1 to M. The specific labels FR and indices j, k, and i are arbitrary and are only for consistent reference to examples in this disclosure. Referring to FIGS. 1 and 3, the plurality 202 of basis functions FR and the N×M pixel frame 204 may be stored in, for example, the data storage 26 of FIG. 1.

Referring again to FIG. 3, the example pixel classification system 200 includes basis means 206 for applying each of the R basis functions FR to all, or any selected subset of the pixels of the N×M pixel frame, and to generate, for each pixel, an R-dimensioned sample classification vector, labeled CV(j,k). For consistency of reference within this disclosure, the applying of the R basis functions to a pixel and generate an R-dimensioned vector will be referenced, generically, as “characterizing a pixel in R feature dimensions.”

The basis functions FR, the generation of the sample classification vector CV(j,k), and the classification based on the sample classification vector CV(j,k) each provide certain significant benefits over the prior art, as will be described in greater detail in reference to specific embodiments and aspects of the invention.

Referring to FIGS. 1 and 3, the basis means 206 for applying each of the R basis functions to generate the R-dimensional classification vector may be implemented by the data processing resource 20, through its data processing unit 24 and machine-executable instructions (not shown) stored in the data storage 26.

With continuing reference to FIG. 3, the example pixel classification system 200 further includes at least one classification class 208, referenced as Centroidᵥ, v=1 to V, which may, for example, have V=2 and comprise Centroid₁ being a first R-dimensioned centroid vector, representing a first subject tissue condition, and Centroid₂ being a second R-dimensioned centroid vector, representing a second subject tissue condition. The first subject condition may, for example, be a given cancer type. The second subject condition may be not having the given cancer type.

According to one embodiment, the classification classes 208, e.g., Centroid₁ and Centroid₂, are formed by a training process that is not separately shown, but is substantially identical to the depicted generation of the sample classification vectors CV(j,k), as will be described. The training comprises, for example, applying the R specific basis functions FR to training pixels from a plurality of training images (not shown). The training pixels are known a-priori to represent ultrasound imaging of a tissue (not shown) having the first subject condition or having the second subject condition. Preferably, the quantity of the pixels known a-priori as representing the first subject condition is greater than a given number B, and the quantity of the pixels known a-priori as representing the second subject condition is greater than a given number G, which may or may not be equal to B. Based on the present disclosure, a person of ordinary skill in the pertinent art can readily determine the value of B to meet a given classification error or confidence factor.

Embodiments of the invention are not, however, limited to V=2, i.e., are not limited to two centroid vectors. Embodiments of the invention are contemplated having means for classifying the pixels of the N×M image into three or more classes, based on three or more centroid vectors.

According to one embodiment, the training process generates the first centroid vector Centroid₁ by applying the R specific basis functions to each of a plurality of B pixels representing the first subject condition and generating, as a result, a plurality of B of the R-dimensioned firs centroid training vectors. Similarly, according to one embodiment, a training process generates the second centroid vector by applying the R specific basis functions to each of the G pixels representing the second subject condition and generated, as a result, a plurality of G of the R-dimensioned second centroid training vectors.

According to one embodiment, the first centroid vector Centroid₁ and the second centroid vector Centroid₂ are formed, respectively, from the plurality of B of the R-dimensioned first centroid training vectors and the plurality of G of the R-dimensioned second centroid training vectors.

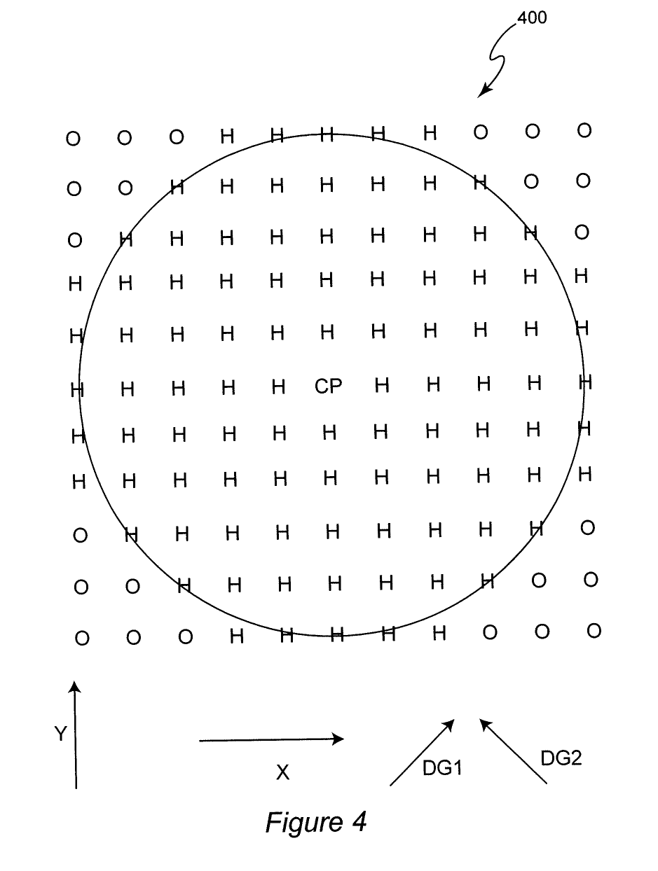

According to one embodiment, a process or algorithm of characterizing the training pixels in R feature dimensions, by aligning a sample mask, such as the FIG. 4 sample mask 400, on each of the B and G pixels and applying the R specific basis functions to the pixels in the window to generate R dimensional training vectors, may be identical to the process or algorithm performed by the basis means 206 for characterizing unknown pixels of a subject image. One example according to one or embodiments of characterizing a generic pixel in R dimensions will therefore be described, and it will be understood that this may be performed by the basis means 206 or by the training process.

In accordance with one embodiment, characterizing a pixel in R dimensions includes identifying a subject pixel, identifying the sample mask having a given pixel dimension surrounding the subject pixel, and then applying each of the R basis functions FR to each of multiple pixel sequences (e.g., one hundred particular sequences of pixel pairs) within the small sample mask surrounding the pixel, to generate a plurality of, for example, one hundred results.

According to one embodiment the sample mask selected with each subject pixel is circular or approximately circular, with the subject pixel preferably at the center. According to one embodiment the sample mask may be square or rectangular. As will be understood from more detailed descriptions, the diameter or radius of the sample mask is preferably substantially smaller than the overall pixel dimension of the subject image.

Referring to FIG. 4, as one illustrative example, an 11×11 window may perform as a circular window with radius 5.8, by using only the pixels marked as an “H”, and not using pixels marked with an “O”. The is only one illustrative example, as other L×L dimensions and other arrangements will be readily apparent to persons skilled in the pertinent arts based on this disclosure.

With continuing reference to FIG. 4, the R basis functions FR are each applied in a direction specific to the particular basis function such as, for example, one of the example horizontal, vertical, first diagonal and second diagonal directions is “X”, Y”, “DG1” and “DG2”.

According to one embodiment, one of the R basis functions FR may be the autocorrelation product of lag 1 in the horizontal or X direction across the sample mask. Referring to FIGS. 3 and 4 together, this example basis function (i.e., the autocorrelation product of lag 1 in the X direction) the basis means 206 calculates the mean of the pixel magnitudes within the circular window, subtracts the mean from each pixel, iterates through the 11 rows, in each iteration scanning left to right and generates a product, for each successive pair pixels, of the first pixel minus the mean multiplied by its adjacent (i.e., lag 1) pixel minus the mean. The number of autocorrelation products of lag 1 in the X direction), for the FIG. 4 example round sample mask 400, is approximately one hundred. The plurality or collection of products will be referenced in this disclosure as “a bucket of values.”

Referring to FIG. 3, configuring the data processing resource 20 having the data processing unit 24 to implement the basis means 206 to perform all of the described calculating of the mean of the pixel magnitudes within the sample mask, subtracting the mean from each pixel, iterating through the pixels, performing the arithmetic operations defined by the particular basis function FR, for each of the R basis functions FR, to generate the R bucket of values FRᵢ(j,k), is well within the skills of a person or ordinary skill in the pertinent arts, based on the present disclosure, by writing and storing appropriate machine-executable instructions (not shown) in the data storage 26.

With continuing reference to FIG. 4, it is seen that if a sample mask similar to FIG. 4 but square with 11×11 dimension were used, the number of pairs in each row is 10 and, therefore, 110 autocorrelation products of lag 1 in the X direction would be generated. In other words, the bucket of values generated by applying a particular basis function of the autocorrelation product of lag 1 would have 110 members.

Referring to FIG. 4, the above-described example illustrated one application of one example basis function FR, namely the autocorrelation product of lag 1 in the labeled horizontal or X direction. Referring to FIG. 3, in the characterizing in R-dimensions of a subject pixel for purposes of classifying, the basis means 206 has means for applying basis functions 208 that iterates through the FIG. 4 sample mask and performs the arithmetic operations according to the each of the R of the basis functions FR, in a manner that may be comparable to the above-described example of lag-1 autocorrelation products, but across different ones of the X, Y DG1 and DG2 directions, and at different pixel spacing in these directions, to generate R buckets of values.

The present inventor has identified the particular disclosed R basis functions FR, combined with the disclosed embodiments' application of these basis functions to pixel windows surrounding a subject pixel, as yielding R buckets have characterizing information sufficient to classify the subject pixel, with an estimated likelihood of error lower than may be provided by the prior art, between a first classification and a second classification.

Referring to FIG. 3, the above-described basis function of autocorrelation products of pixels spaced at lag-1 along the labeled X-direction, one embodiment includes the plurality 202 of basis functions FR having any one of, or having all of: (a) autocorrelation product functions of pixels spaced at lag-1 along each of a plurality of directions; (b) arithmetic difference functions approximating a first partial derivative of pixel magnitudes along each of a plurality of directions; (c) arithmetic difference of difference functions approximating a second partial derivative of pixel magnitudes along each of a plurality of directions; (d) autocorrelation product functions of pixels spaced at lag-2 along each of a plurality of directions; (e) autocorrelation product functions of pixels spaced at lag-3 along each of a plurality of directions; and (f) a function representing each pixel's deviation from an average magnitude over the sample mask. The particular example labels (a) through (f) are arbitrary and their particular order of listing is irrelevant.

With continuing reference to FIG. 3, one plurality 202 of basis functions may have any one, any combination of, or the entirety of, for example, twenty-one basis functions, which may be labeled arbitrarily FR₁ . . . FR₂₁. One example of twenty-one basis functions FR may be illustrated in reference to the FIG. 4 11×11 sample mask 400.

FR₁ may be an autocorrelation product of pixels spaced at lag-1 along, for example, the labeled X-direction of the sample mask 400. FR₂ may be an autocorrelation product of pixels spaced at lag-1 along, for example, the labeled Y-direction of the sample mask 400. FR₃ may be an autocorrelation product of pixels spaced at lag-1 along, for example, the labeled DG1-direction of the sample mask 400. FR₄ may be an autocorrelation product of pixels spaced at lag-1 along, for example, the labeled DG2-direction of the sample mask 400. The “autocorrelation product” means for pair of pixels spaced by the lag number in the direction specified by the basis function (e.g., the X-direction), the first pixel minus the mean multiplied by the other (i.e., lag 1, etc.) pixel minus the mean. One example form is:

$$AP ( r , s ) = \frac{( ( r , s ) - {μ}_{j , k} ) \cdot ( ( r - 1 , s ) - {μ}_{j , k}}{{σ}^{2}} \qquad ( Eq . 1 )$$

where AP(r,s) is the autocorrelation product of the pair of pixels relative to an arbitrary pixel (r,s) within the sample mask, (r,s) is the magnitude of the r,s pixel, (r-1,s) is the magnitude of the pixel spaced at lag-1 (in the X-direction for this example), μ_{j,k} is the mean of the pixels within the sample mask that is aligned (e.g., centered) on the subject alignment pixel j,k, and σ² is the variance of the pixels within the mask.

The phrase “lag-1” appearing in the example definitions of the example basis functions FR₁ through FR₄ may, but does not necessarily, define a one-pixel spacing in the direction defined by the basis function, e.g., the X, Y, DG1 or DG2 example directions. This is only one example, Alternatively, “lag-1” may be a normalized one unit spacing of, for example two pixels.

Continuing with one example having twenty-one basis functions, FR₅ may be an arithmetic difference function approximating a first partial derivative of pixel magnitudes along, for example, the labeled X-direction of the sample mask 400. FR₆ may be an arithmetic difference function approximating a first partial derivative of pixel magnitudes along, for example, the labeled Y-direction of the sample mask 400. FR₇ may be an arithmetic difference function approximating a first partial derivative of pixel magnitudes along the labeled DG1-direction. FR₈ may be an arithmetic difference function approximating a first partial derivative of pixel magnitudes along the labeled DG2-direction. FR₉ may be an arithmetic difference of the difference, or equivalent function, approximating a second partial derivative of pixel magnitudes along the labeled X-direction. FR₁₀ may be an arithmetic difference of the difference or equivalent function, approximating a second partial derivative of pixel magnitudes along the labeled Y-direction. FR₁₁ may be an arithmetic difference of the difference, or equivalent function, approximating a second partial derivative of pixel magnitudes along the labeled DG1-direction. FR₁₂ may be an arithmetic difference of the difference, or equivalent function, approximating a second partial derivative of pixel magnitudes along the labeled DG2-direction. FR₁₃ may be an autocorrelation product of pixels spaced at lag-2 along the labeled X-direction. FR₁₄ may be an autocorrelation product of pixels spaced at lag-2 along the labeled Y-direction. FR₁₅ may be an autocorrelation product of pixels spaced at lag-2 along the labeled DG1-direction. FR₁₆ may be an autocorrelation product of pixels spaced at lag-2 along the labeled DG2-direction. FR₁₇ may be an autocorrelation product of pixels spaced at lag-3 along the labeled X-direction. FR₁₈ may be an autocorrelation product of pixels spaced at lag-3 along the labeled Y-direction. FR₁₉ may be an autocorrelation product of pixels spaced at lag-3 along the labeled DG1-direction. FR₂₀=an autocorrelation product of pixels spaced at lag-3 along the labeled DG2-direction. FR₂₁ may be a function representing each pixel's deviation from an average pixel magnitude over the sample mask.

It will be understood that the labeling FR₁ and their order of listing is arbitrary and without operational significance.

According to one embodiment, the classifying and classifying means 206 also include means 210 for generating an estimate of a probability density function, which may be referenced as E{PDF (FRᵢ(j,k))}, one for each of the R buckets FRᵢ(j,k), based on the collection of values within the bucket. According to one aspect, classifying and classifying means perform the estimate by generating a histogram sample-based estimate for each of the R buckets of results. Referring to FIG. 3, one example system includes PDF means 210 arranged to generate this histogram estimate. As will be readily understood, the PDF means 210 may be implemented by, for example, the data processing resource 20, through the data processing unit 24 and machine-executable instructions (not shown) stored in the data storage 26.

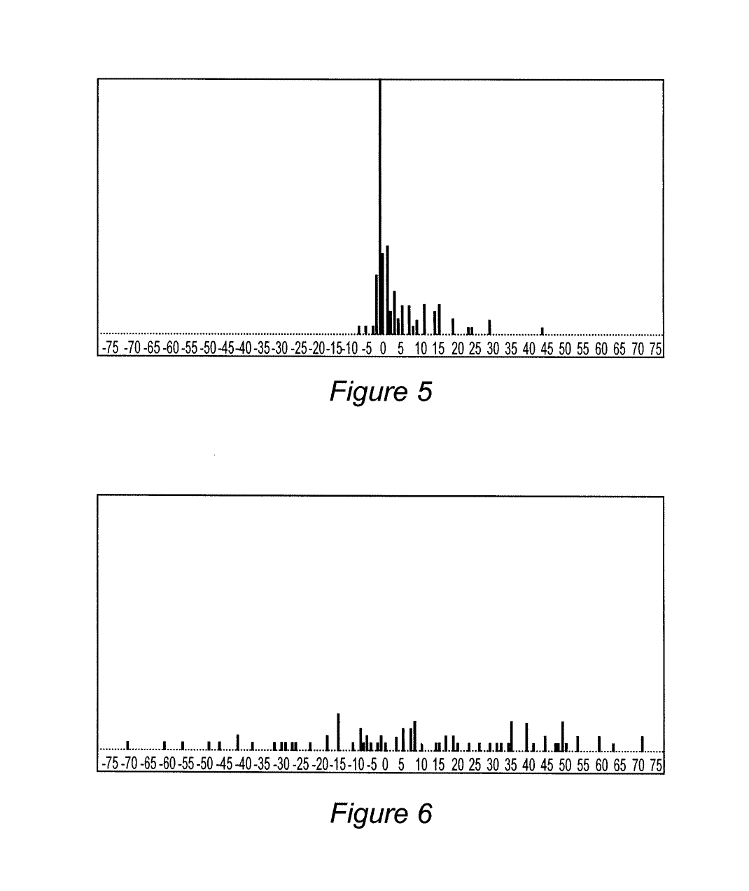

FIG. 5 shows, as one illustrative example, one computer-calculated histogram of results of applying a basis function approximating to a first partial derivative of pixel magnitudes along the labeled x-direction of the FIG. 4 sample mask, where the center pixel CP and all other pixels in the sample mask were taken from actually obtained ultrasound image of a cancer free area of a prostate gland. According to one embodiment, the specific basis function approximating the first partial derivative of pixel magnitudes along the labeled x-direction of the FIG. 4 sample mask is simply a difference function, as will be described in greater detail. With continuing reference to FIG. 5, the horizontal axis HX represents magnitude bins and the vertical axis VX represents the number of values in each bin.

Referring to FIG. 3, one implementation of the PDF means 210 is by configuring data processing resource 20, with the data processing unit 24, by writing and storing appropriate machine-executable instructions (not shown) in the data storage 26. Writing machine-executable instructions to implement the PDF means 210 to perform all of the described histogram generating operations is well within the skills of a person or ordinary skill in the pertinent arts, based on the present disclosure.

To compare with FIG. 5, FIG. 6 shows one computer-calculated histogram of results of applying the same basis function that was applied in generating the FIG. 5 histogram, to a sample mask as shown in FIG. 4 of pixels were taken from actually obtained ultrasound image of a cancerous area of a prostate gland.

Comparing FIG. 5 and FIG. 6, the difference information obtained by generating the histogram is clear. Computer simulations show the histograms as providing still further characterizing information, thereby providing further reduction in pixel classification error. Further, FIGS. 5 and 6 show only the difference of histograms obtained from one disclosed basis function, upon application to a non-cancerous as compared to a cancerous tissue. According to some embodiments, the number of basis functions included in the classification and classification means is much larger. According to one embodiment, the classification and means for classifying include twenty-one different, particular basis functions.

In accordance with one embodiment, the classification and classification means may be arranged to store a given classification criterion and to classify a subject pixel, based on the given classification criterion and on the generated plurality of R histograms or equivalent probability density estimations obtained from applying the R basis functions to the subject pixel and its surrounding window.

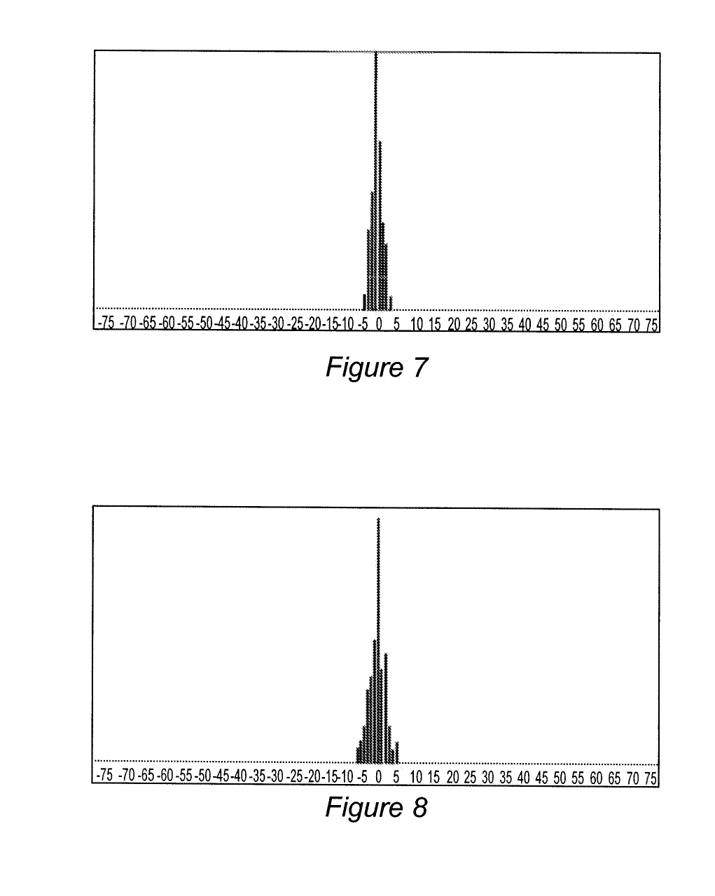

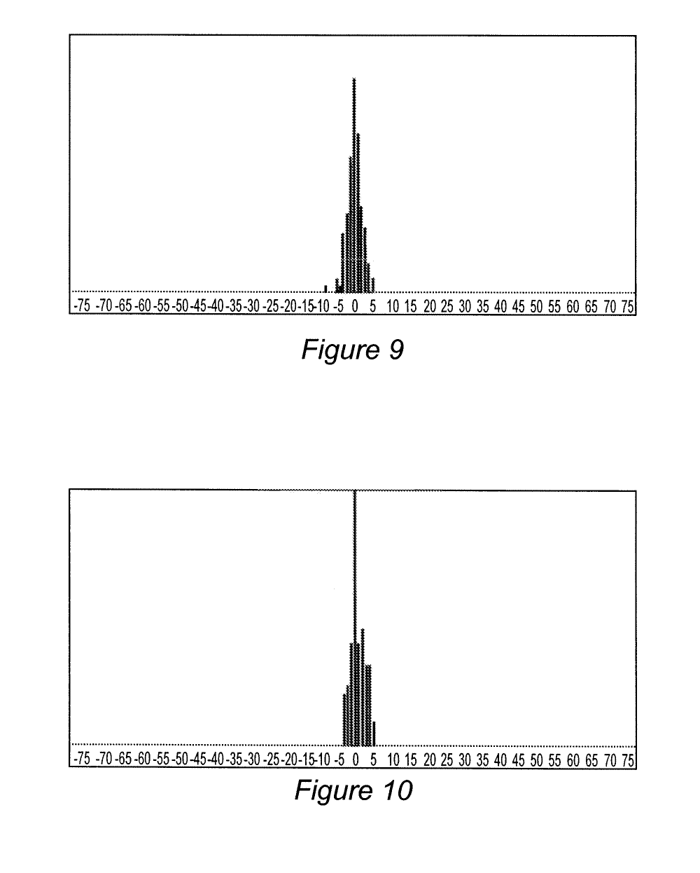

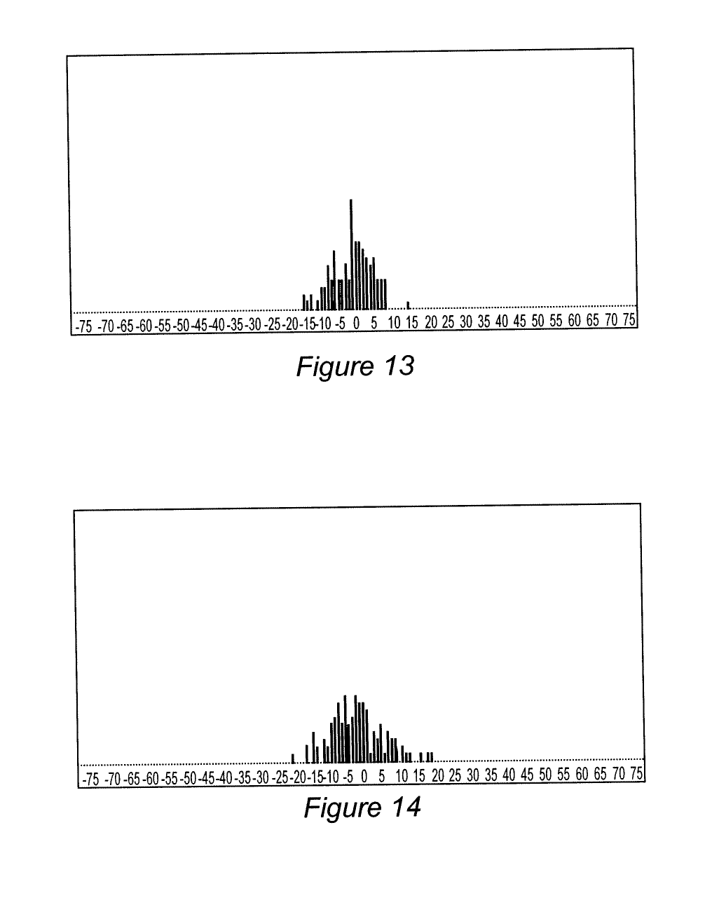

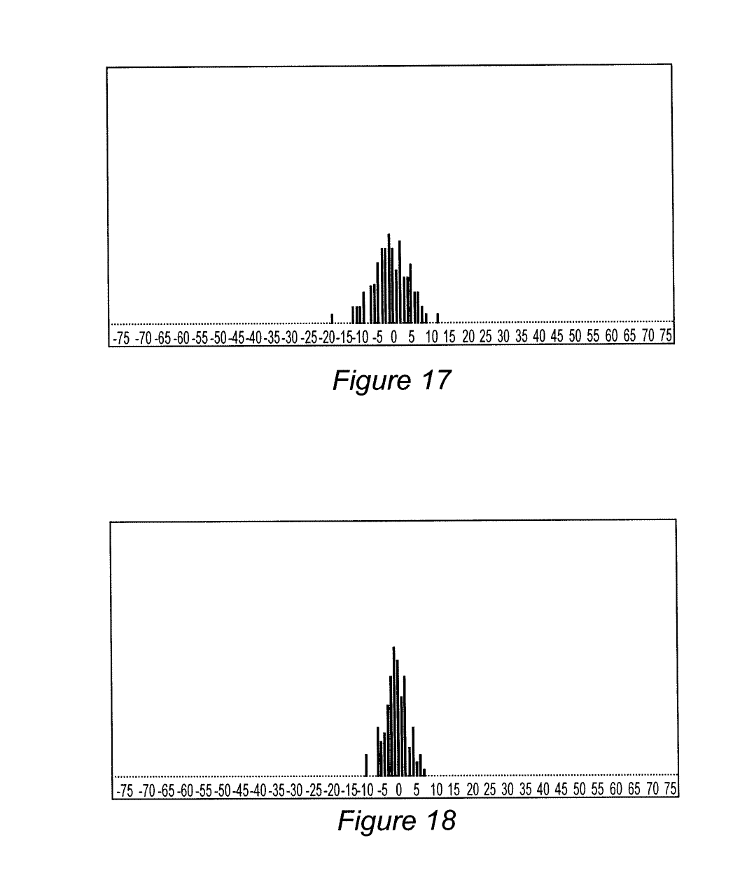

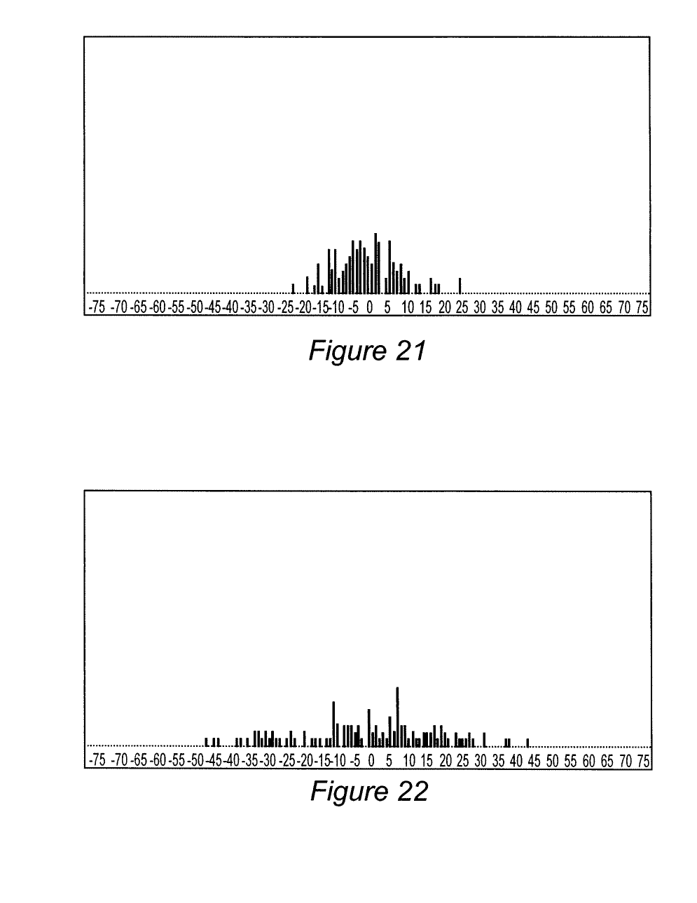

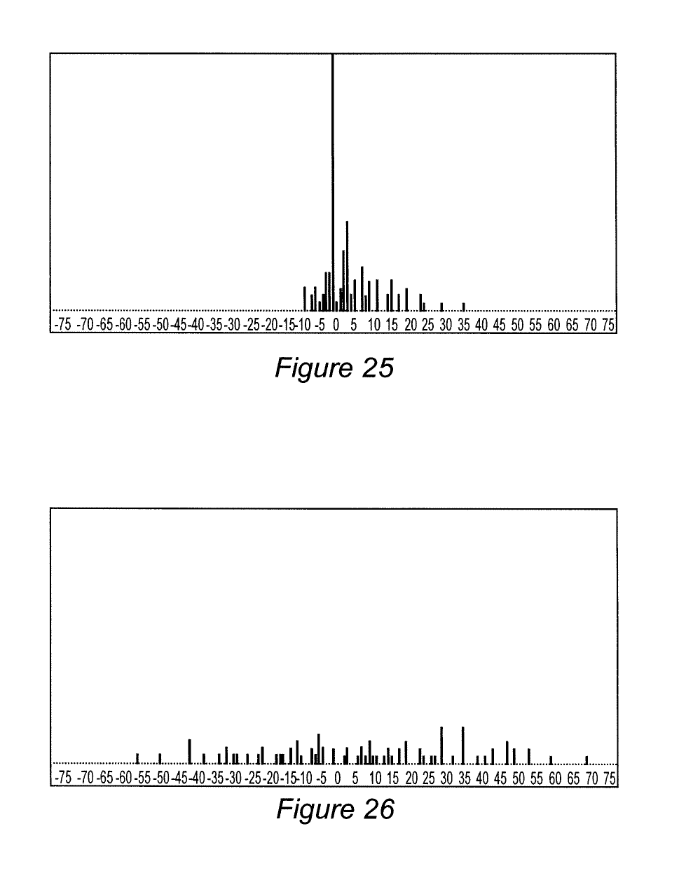

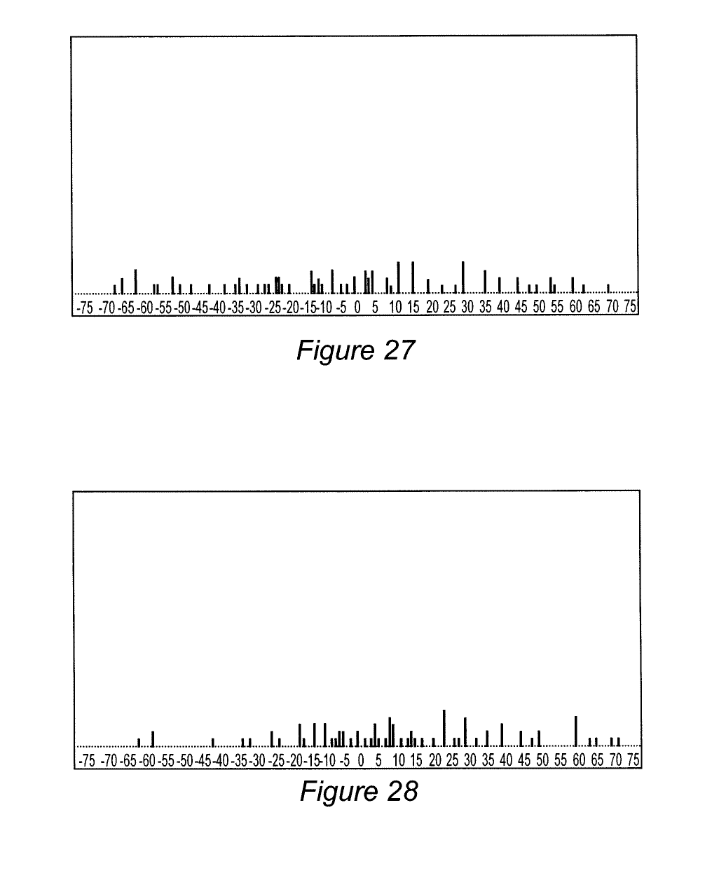

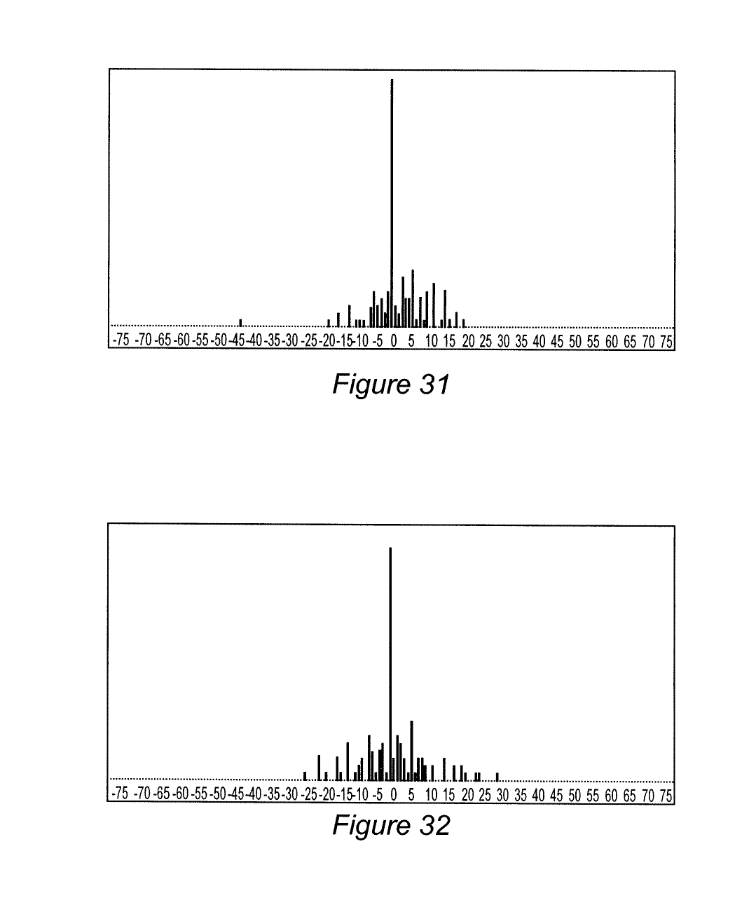

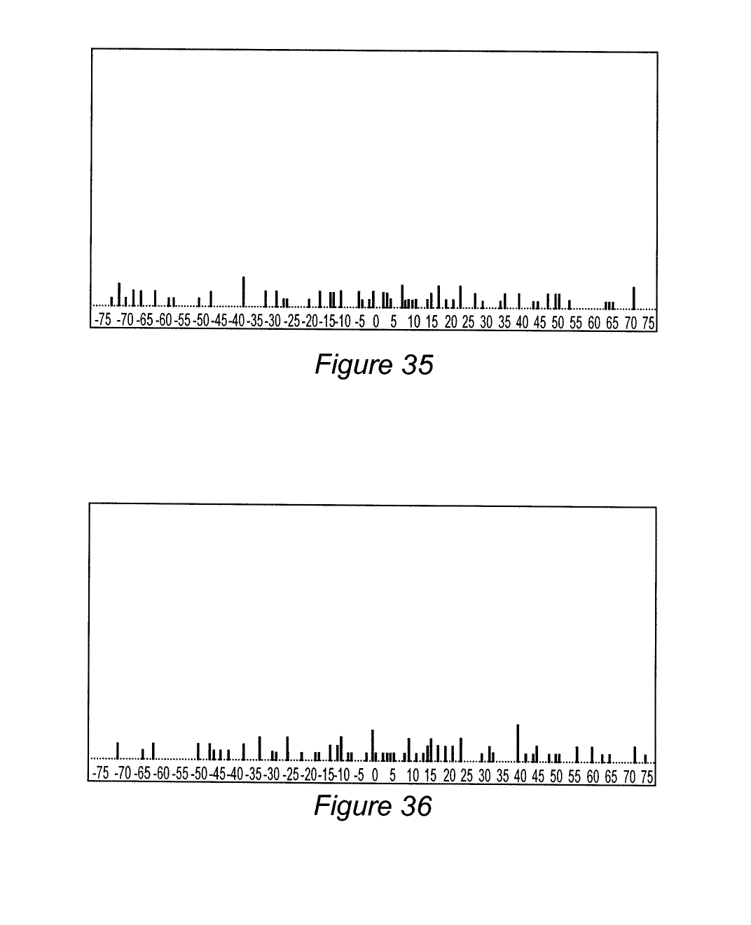

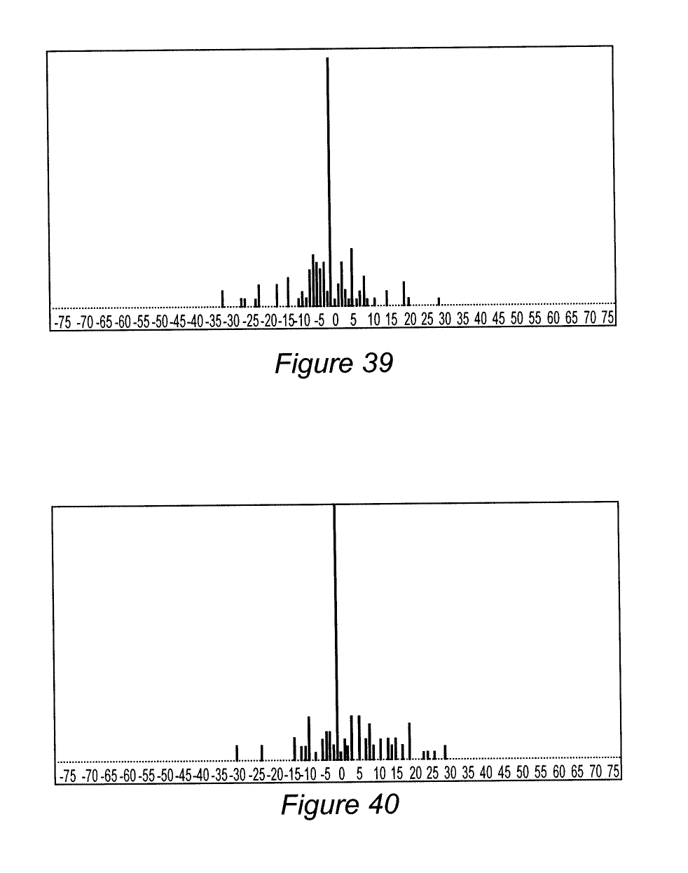

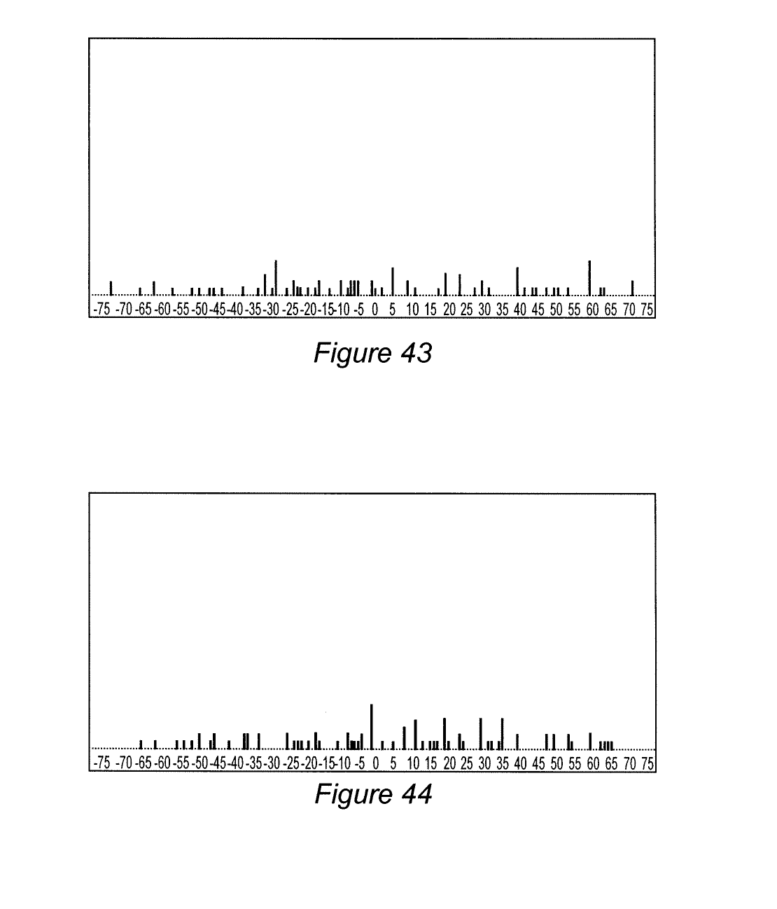

FIGS. 7 through 45 graphically illustrate computer-calculated probability density estimations E{PDF(FRᵢ(j,k))}, obtained from applying the R basis functions FR to a subject pixel j,k corresponding to a non-cancerous prostate tissue and to a subject pixel of an image j,k corresponding to a cancerous prostate tissue. The differences of the respective estimated probability densities E{PDF(FRᵢ(j,k))} between the cancerous and non-cancerous pixels are readily seen.

Referring to FIGS. 7-10, these figures graphically illustrate respective computer-calculated histogram estimates of a probability density function of results, or buckets of values, obtained from applying basis functions FR approximating, respectively, a first partial derivative of pixel magnitude with respect to spatial displacement, along the labeled X-direction, along the Y-direction, along the DG1 diagonal direction and along the DG2 diagonal direction of the FIG. 4 sample 11×11 sample mask 400, centered on a pixel j,k corresponding to non-cancerous prostate tissue. As readily understood by a person of ordinary skill in the pertinent art, based on this disclosure, the approximation of the first partial derivative may be performed based on the difference between the magnitude of a pixel and a pixel adjacent in the direction of the partial derivative. Machine-executable instructions for the FIG. 1 data processor 24 to perform such operations, or equivalent, are easily written, in view of this disclosure, by a person of ordinary skill in the pertinent art.

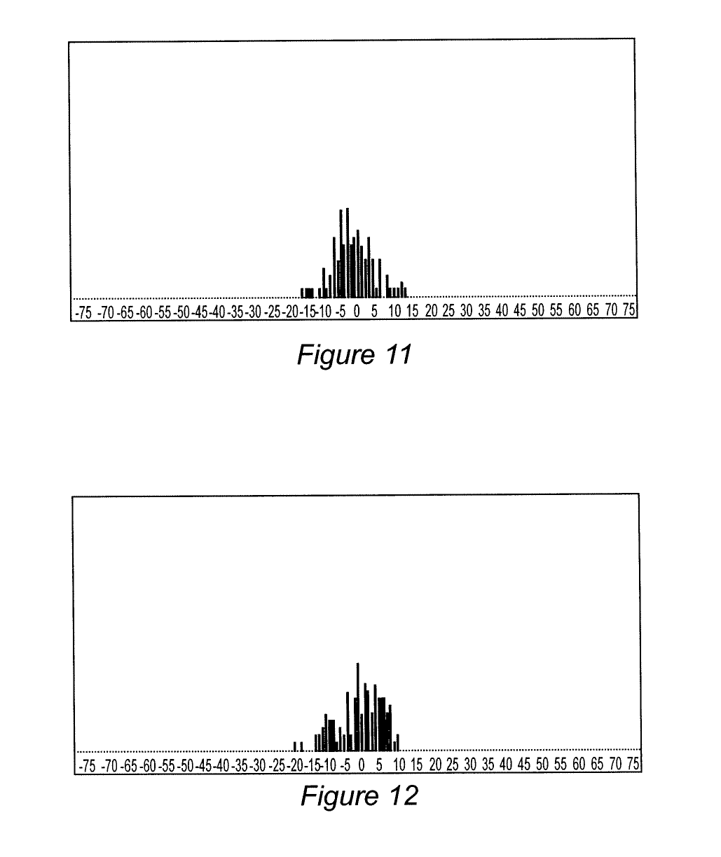

FIGS. 11-14 graphically illustrate respective computer-calculated histogram estimates of a probability density function of results, or buckets of values, obtained from applying the same basis functions applied to generate FIGS. 7-10, but to a FIG. 4 sample 11×11 sample mask 400 centered on a pixel j,k corresponding to cancerous prostate tissue. The differences of the respective estimated probability densities between the cancerous and non-cancerous pixels are readily seen.

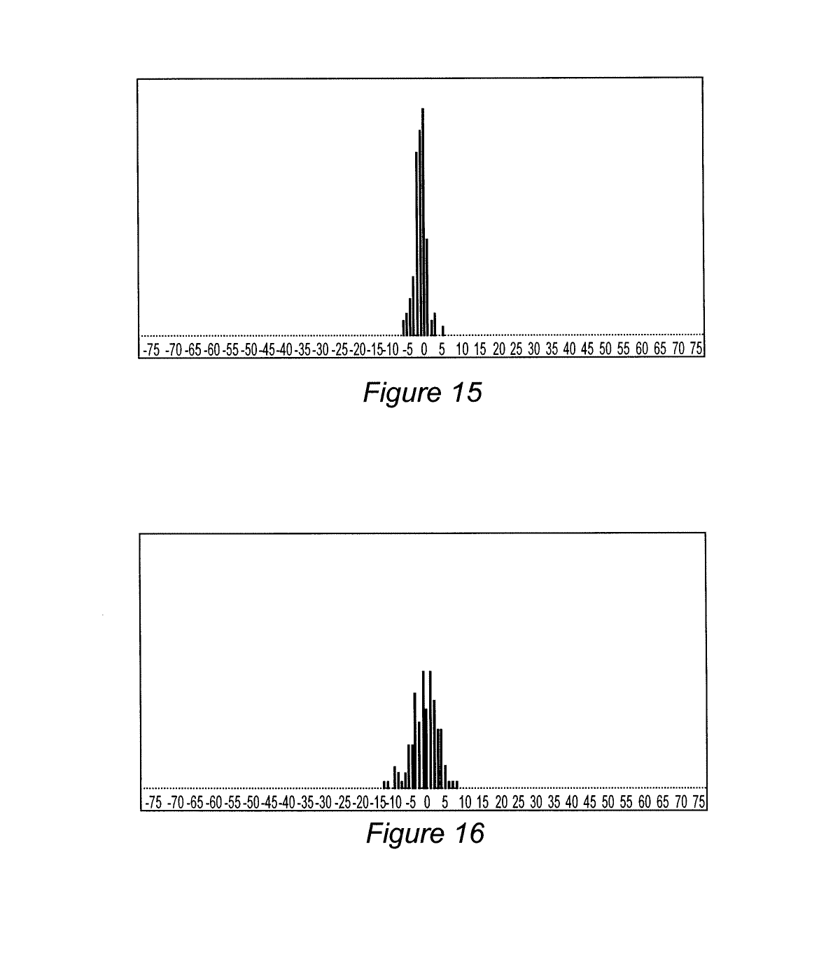

FIGS. 15-18 graphically illustrate respective computer-calculated histogram estimates of a probability density function of results, or buckets of values, obtained from applying basis functions FR approximating, respectively a second partial derivative of pixel magnitudes along the labeled X-direction, a second partial derivative of pixel magnitudes along the labeled Y-direction, a second partial derivative of pixel magnitudes along the labeled DG1 diagonal direction, and a second partial derivative of pixel magnitudes spaced at lag 1 along the labeled DG2 diagonal direction of the FIG. 4 sample 11×11 sample mask 400, centered on a pixel j,k corresponding to non-cancerous prostate tissue.

The approximation of the second partial derivative may be performed based on the difference between the magnitude of a pixel and adjacent in the direction of the partial derivative, storing the difference, and calculating the difference between stored differences. Machine-executable instructions for the FIG. 1 data processor 24 to perform these operations, or equivalent operations, are easily written and stored in, for example, the data storage 26, in view of this disclosure, by a person of ordinary skill in the pertinent art.

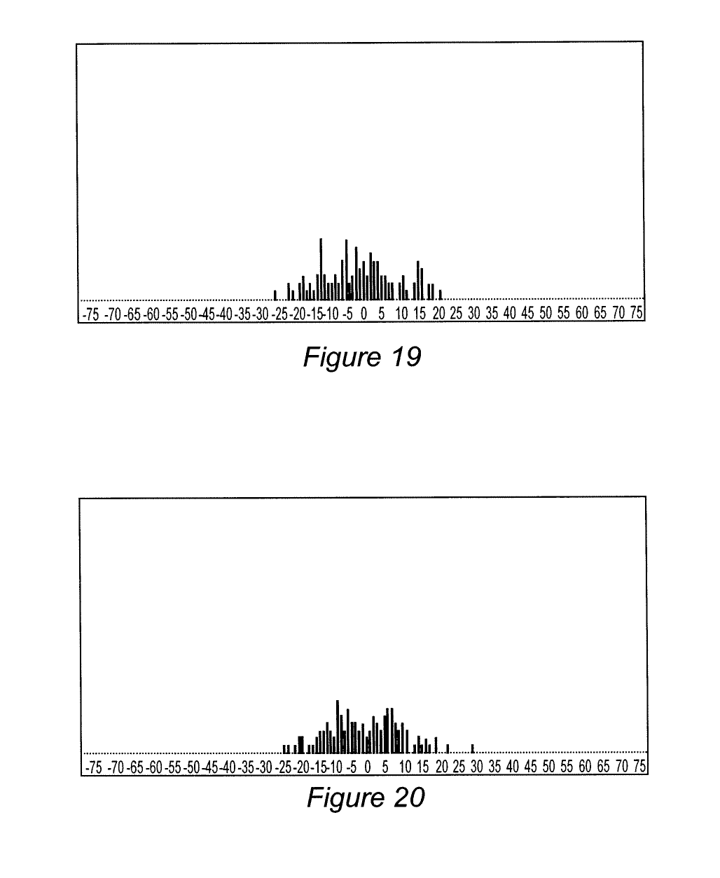

FIGS. 19-22, on the other hand, graphically illustrate respective computer-calculated histogram estimates of a probability density function of calculated values approximating, respectively, the same second partial derivative basis functions applied to generate FIGS. 15-18 but to a FIG. 4 sample 11×11 sample mask 400 centered on a pixel j,k corresponding to cancerous prostate tissue. The differences of the respective estimated probability densities between the cancerous and non-cancerous pixels are readily seen.

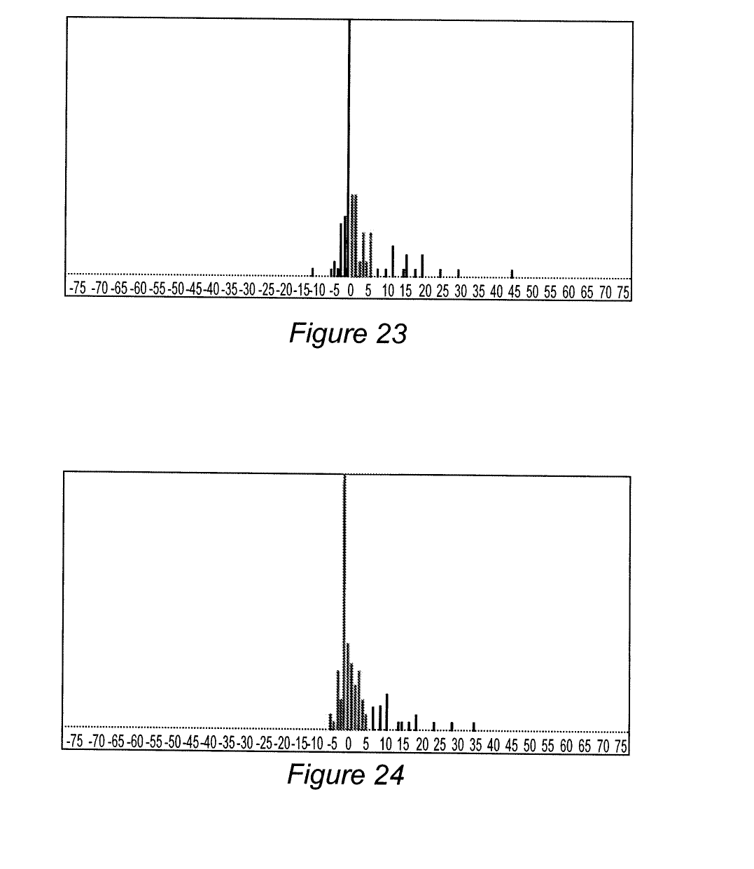

FIGS. 23-25 graphically illustrate respective computer-calculated histogram estimates of a probability density function of results, or buckets of values, obtained from applying basis functions FR defined as, or approximating autocorrelation products of pixels spaced at lag-1 along the Y-direction, along the DG1 diagonal direction and along the DG2 diagonal direction of the FIG. 4 sample 11×11 sample mask 400, centered on a pixel j,k corresponding to non-cancerous prostate tissue. The computer histogram of applying this lag-a basis function FR along the X-direction is shown in FIG. 5, as described above.

As readily understood by a person of ordinary skill in the pertinent art, based on this disclosure, the autocorrelation products of pixels spaced at lag-1 means, for pairs of pixels spaced by the lag number in the direction specified by the basis function, the first pixel minus the mean multiplied by the other (i.e., lag 1, etc.) pixel minus the mean. Machine-executable instructions for the FIG. 1 data processor 24 to perform such operations, or equivalent, are easily written, in view of this disclosure, by a person of ordinary skill in the pertinent art.

FIGS. 26-28 on the other hand, graphically illustrate respective computer-calculated histogram estimates of a probability density function of calculated values approximating, respectively, the same lag-1 autocorrelation function applied to generate FIGS. 23-25 but to a FIG. 4 sample 11×11 sample mask 400 centered on a pixel j,k corresponding to cancerous prostate tissue. Differences of the respective estimated probability densities between the cancerous and non-cancerous pixels are apparent. The computer histogram of applying this lag-1 basis function FR along the X-direction is shown in FIG. 6, and its comparison to FIG. 5 is described above.

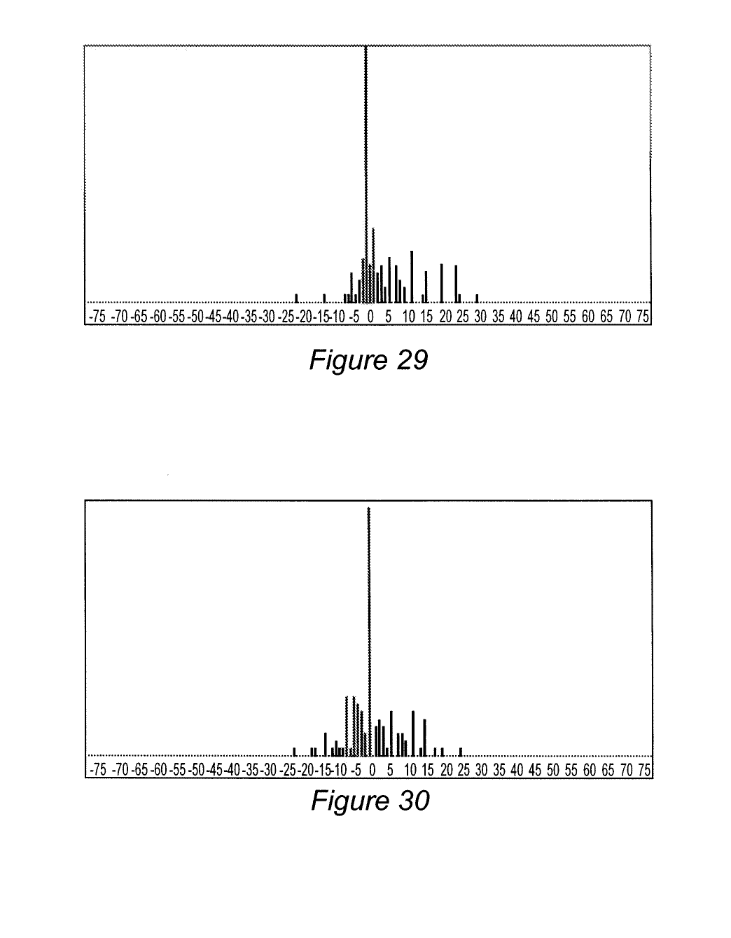

FIGS. 29-32 graphically illustrate respective computer-calculated histogram estimates of a probability density function of results, or buckets of values, obtained from applying basis functions FR defined as, or approximating autocorrelation products of pixels spaced at lag-2 along the X-direction, along the Y-direction, along the DG1 diagonal direction and along the DG2 diagonal direction of the FIG. 4 sample 11×11 sample mask 400, centered on a pixel j,k corresponding to non-cancerous prostate tissue. As readily understood by a person of ordinary skill in the pertinent art, based on this disclosure, the autocorrelation products of pixels spaced at lag-2 may be defined substantially the same as the lag-1 autocorrelation function, except that the pixels are spaced two units instead of one unit in the direction specified by the basis function. Machine-executable instructions for the FIG. 1 data processor 24 to perform such operations, or equivalent, are easily written, in view of this disclosure, by a person of ordinary skill in the pertinent art.

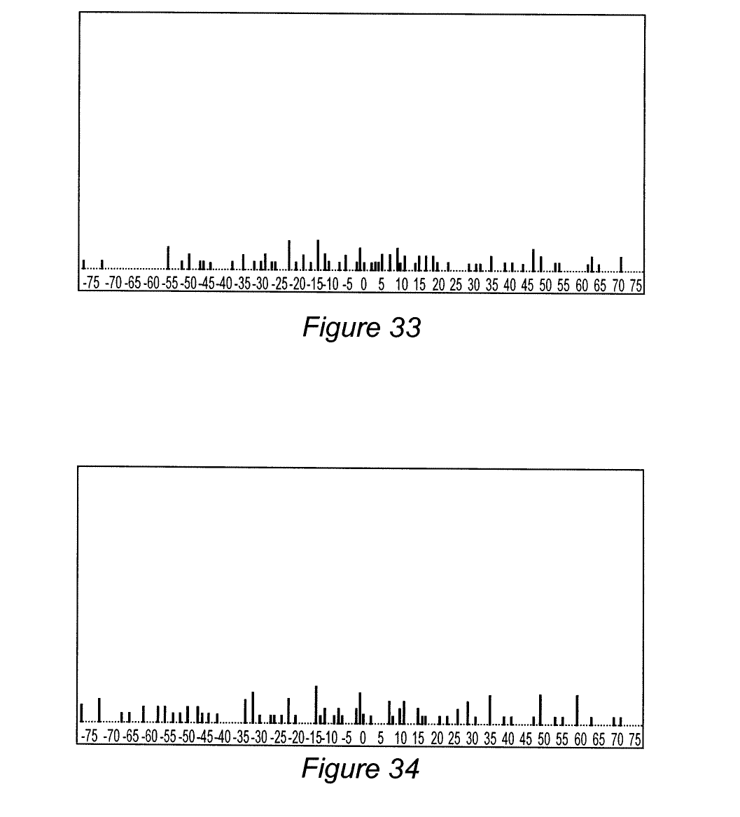

FIGS. 33-36 on the other hand, graphically illustrate respective computer-calculated histogram estimates of a probability density function of calculated values approximating, respectively, the same lag-2 autocorrelation function applied to generate FIGS. 29-32, but applied to a FIG. 4 sample 11×11 sample mask 400 centered on a pixel j,k corresponding to cancerous prostate tissue. Differences of the respective estimated probability densities between the cancerous and non-cancerous pixels are apparent.

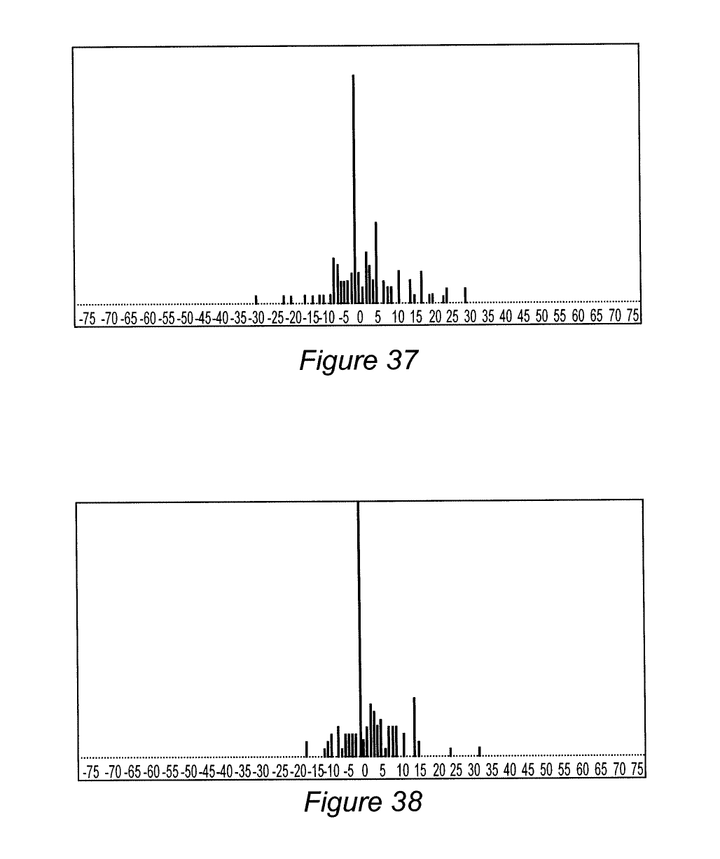

FIGS. 37-49 graphically illustrate respective computer-calculated histogram estimates of a probability density function of results, or buckets of values, obtained from applying basis functions FR defined as, or approximating autocorrelation products of pixels spaced at lag-3 along the X-direction, along the Y-direction, along the DG1 diagonal direction and along the DG2 diagonal direction of the FIG. 4 sample 11×11 sample mask 400, centered on a pixel j,k corresponding to non-cancerous prostate tissue. As readily understood by a person of ordinary skill in the pertinent art, based on this disclosure, the autocorrelation products of pixels spaced at lag-3 may be defined substantially the same as the lag-2 and lag-3 autocorrelation functions, except that the pixels are spaced three units in the direction specified by the basis function. Machine-executable instructions for the FIG. 1 data processor 24 to perform such operations, or equivalent, are easily written, in view of this disclosure, by a person of ordinary skill in the pertinent art.

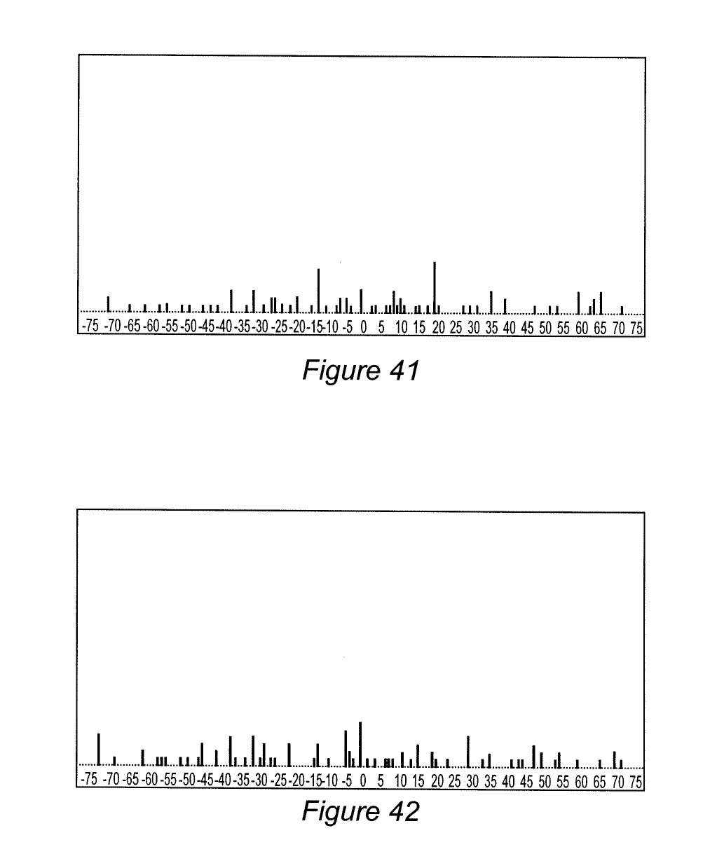

FIGS. 41-44 on the other hand, graphically illustrate respective computer-calculated histogram estimates of a probability density function of calculated values approximating, respectively, the same lag-3 autocorrelation function applied to generate FIGS. 37-40 but to a FIG. 4 sample 11×11 sample mask 400 centered on a pixel j,k corresponding to cancerous prostate tissue. Differences of the respective estimated probability densities between the cancerous and non-cancerous pixels are apparent.

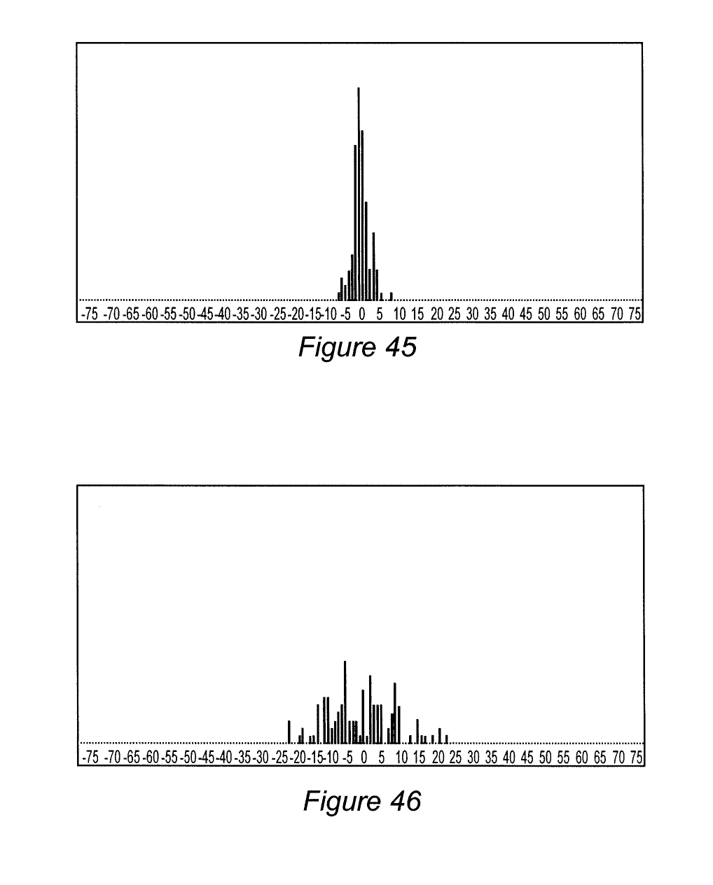

FIG. 45 graphically illustrates one computer-calculated histogram reflecting a probability density function of results, or buckets of values, obtained from applying a basis function FR defined as, or approximating each pixel's deviation from an average magnitude over the FIG. 4 sample 11×11 sample mask 400, centered on a pixel j,k corresponding to non-cancerous prostate tissue.

FIG. 46, in comparison, graphically illustrates respective computer-calculated histogram estimates of a probability density function of calculated values approximating, respectively, the deviation-from-mean function applied to generate FIG. 45 but to a FIG. 4 sample 11×11 sample mask 400 centered on a pixel j,k corresponding to cancerous prostate tissue. Differences of the respective estimated probability densities between the cancerous and non-cancerous pixels are readily apparent.

Referring again to FIG. 3, in accordance with some embodiments, the classifying and classifying means further includes transforming means 212 for transforming the generated histogram estimations of the R probability density functions, which are multi-valued (e.g., as shown in FIGS. 5 and 6) to a single value. According to one aspect, the transforming means 212 includes calculating a mean of the histogram values for each of the R histograms, to generate an R-dimensional vector for each subject pixel. Referring to FIG. 3, one implementation of the transforming means 212 is by configuring data processing resource 20, with the data processing unit 24, by writing and storing appropriate machine-executable instructions (not shown) in the data storage 26. Writing machine-executable instructions to implement the transforming means 212 to perform the mean calculation operations is well within the skills of a person or ordinary skill in the pertinent arts, based on the present disclosure.

Referring to FIGS. 5-46, the mean of each depicted calculated histogram may be calculated by multiplying each bin value by the number of results in the bin, and then dividing by the total number of results.

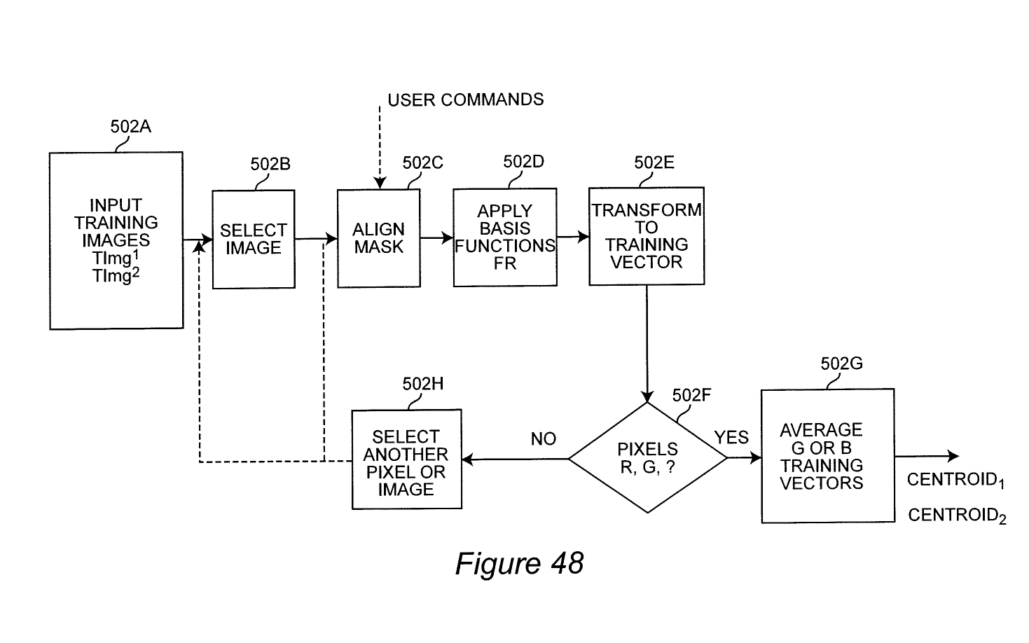

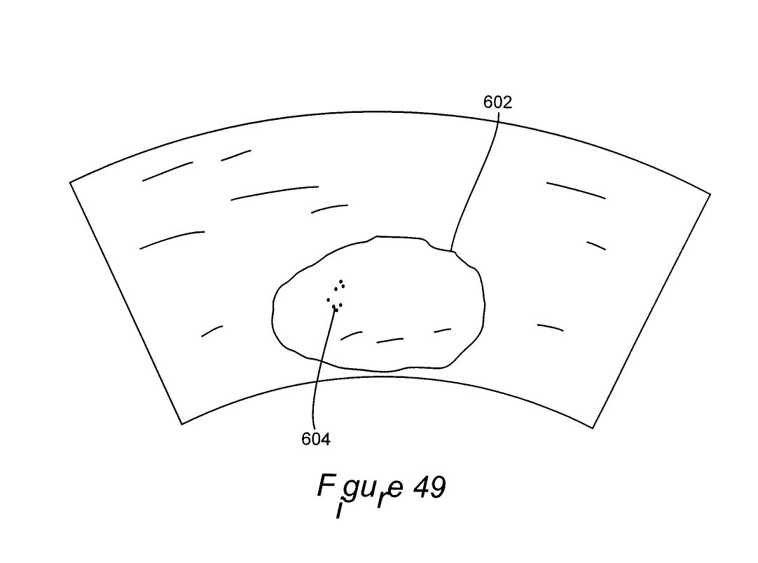

As described above, according to one embodiment, a training process such as described in greater detail in reference to FIG. 48 generates the first centroid vector Centroid₁ by applying the R specific basis functions FR that will be applied for classifying unknown pixels to each of a plurality of B pixels representing the first subject condition and generating, as a result, a plurality of B of the R-dimensioned first centroid training vectors. Similarly, the training process according to the one embodiment generates the second centroid vector Centroid₂ by applying the R specific basis functions to each of the G pixels representing the second subject condition and generated, as a result, a plurality of G of the R-dimensioned second centroid training vectors. According to one embodiment, as described in greater detail, the first centroid vector Centroid₁ and the second centroid vector Centroid₂ are then formed, respectively, from the plurality of B and G of the R-dimensioned first centroid training vectors and second centroid training vectors, respectively. The first centroid vector Centroid₁ and the second centroid vector Centroid₂ may be formed, respectively, from an average of the plurality of B first centroid training vectors and an average of the plurality of G second centroid training vectors.

According to one embodiment, the variance-covariance vectors, collectively labeled CV1, for all of the G first centroid training vectors are calculated and stored, and the variance-covariance vectors, collectively labeled CV2, for all of the B second centroid training vectors may be calculated and stored (not shown).

According to one embodiment, the operations of characterizing the training pixels in R dimensions may be identical to the process or algorithm performed by the means 206 in characterizing in R dimensions the pixels of a subject image. One example process or algorithm for characterizing a generic pixel in R dimensions will therefore be described, and it will be understood that this may be performed by the classifying means 206 in its classification of an unknown pixel j,k or by the training process in generating an R-dimensioned first centroid training vectors and R-dimensioned second centroid training vectors based on known training pixels.

Referring to FIG. 3, in accordance with one embodiment a classifying means 214 is arranged to classify each subject pixel of an image by characterizing the pixel in R dimensions and then to compare, or otherwise discriminate the R-dimensional sample vector between, for example, the first centroid Centroid₁ and the second centroid Centroid₂ to generate a classification.

Referring to FIG. 1, one embodiment includes a display, such as display 34 arranged in combination with, for example, machine-executable instructions stored in the data storage 26, to present a visual representation to the user of the subject image, or a selected portion or zoom of a portion of the image, and further arranged to represent by, for example, a color coding or equivalent highlighting, the class that the classifying or classifying means associated with each pixel, or a region of pixels of the subject image.

Referring to FIG. 3, according to one embodiment the classifying means 214 for classifying a pixel between, for example, the first centroid vector Centroid₁ and the second centroid vector Centroid₂ may include an initial classification and a confirming classification (not shown in FIG. 3). One example initial classification and confirming classification is described in greater detail in reference to FIG. 46. According to one aspect, the initial classification may include calculating a distance between the R-dimensional sample vector and each of a first classifier, e.g., Centroid₁, and a second classifier, e.g., Centroid₂.

Referring to FIG. 3, according to the aspect, the classifying means 214 for classifying a pixel may include a given first threshold distance Mₙ for measuring proximity of a pixel's R-dimensional sample classifying vector and the first centroid vector Centroid₁ and a given second threshold distance Mc, for measuring proximity of a pixel's R-dimensional sample classifying vector and the second centroid vector Centroid₂.

According to one embodiment, the classifying means 214 is arranged to calculate, in the initial classification, a first evaluation distance between the pixel's R-dimensional classification vector and the first centroid vector Centroid₁, and a second evaluation distance between the pixel's R-dimensional classification vector and the second centroid vector Centroid₂.

In accordance with one aspect, the classifying means 214 is arranged to classify, in the initial classification, the subject pixel as a first pixel kind, generically referenced NCPix, based on a concurrence of the first evaluation distance being less than Mₙ and the second evaluation distance being greater than M_{c}. The first pixel kind NCPix may, for example, indicate a non-cancerous tissue.

Further in accordance with one aspect, the classifying means 214 may be arranged to classify, in the initial classification, the subject pixel as a second pixel kind, generically referenced CNPix, based on a concurrence of the first evaluation distance being greater than Mₙ and the second evaluation distance being less than Mc. The second pixel kind CNPix may, for example, indicate a cancerous tissue.

Further in accordance with one aspect, the classifying means 214 may be arranged to classify, in the initial classification, the subject pixel as a pixel intersection kind, generically referenced NX_Pix, based on a concurrence of the first evaluation distance being less than Mₙ and the second evaluation distance being less than M_{c}. The pixel intersection kind indicates the subject pixel may be a pixel first kind NCPix or may be a pixel second kind CNPix, but that the initial classifying cannot meet a given error rate.

The phrase “error rate” is defined in this disclosure as a combination of what is referenced herein as “false negative” and what is referenced herein as “false negative.” It will be understood that “negative” and “positive” are merely relative terms, and may be reversed. The phrase “false negative” may mean a pixel that, in fact, represented a tissue having the second subject condition, e.g., being cancerous, but is classified by the classifying means 214 as being the pixel firs kind NCPix, e.g., being non-cancerous. The phrase “false positive” may mean a pixel that, in fact, represented a tissue having the first subject condition, e.g., being non-cancerous, but classified by the classifying means as being the pixel first kind NCPix, e.g., being non-cancerous.

As will be understood by persons of ordinary skill in the pertinent arts in view of this disclosure, each of “false negative” and “false positive” has a cost. Accordingly, a person of ordinary skill in the pertinent art will readily understand that the first threshold distance Mₙ the second threshold distance Mₙ may be adjusted to move the statistics of the false negative and the false positive to an acceptable, or more acceptable value.

Referring again to FIG. 3, according to one aspect the classifying means 214 may be arranged to perform a second, or confirming classification on each pixel classified by the initial classification as being the pixel intersection kind NX_Pix. In accordance with one aspect, the confirming classifying may classify the subject pixel as being the pixel first kind NCPix or the pixel second kind CNPix based on a subsequent initial classification of a certain quantity of neighbors of the subject pixel. One illustrative example is to classify the subject pixel as being the pixel second kind CNPix if at least eight neighbors of the subject pixel are classified in their initial classifying as being the pixel second kind CNPix. Classifying the eight pixel neighbors may include a sequence of at least eight iterations, each iteration including moving the sample mask (e.g., the FIG. 4 mask 400), to be centered on the particular neighbor pixel, applying the R basis functions FR and generating the R buckets of values, estimating the R probability density functions, transforming each to an R-dimensional classification vector, and comparing the vector to the first centroid vector Centroid₁ and the second centroid vector Centroid₂.

Referring to FIG. 3, one implementation of the classifying means 214 is by configuring data processing resource 20, with the data processing unit 24, by writing and storing appropriate machine-executable instructions (not shown) in the data storage 26. Writing machine-executable instructions to implement the classifying means 214 to perform the above-described distance and comparison operations is well within the skills of a person or ordinary skill in the pertinent arts, based on the present disclosure.

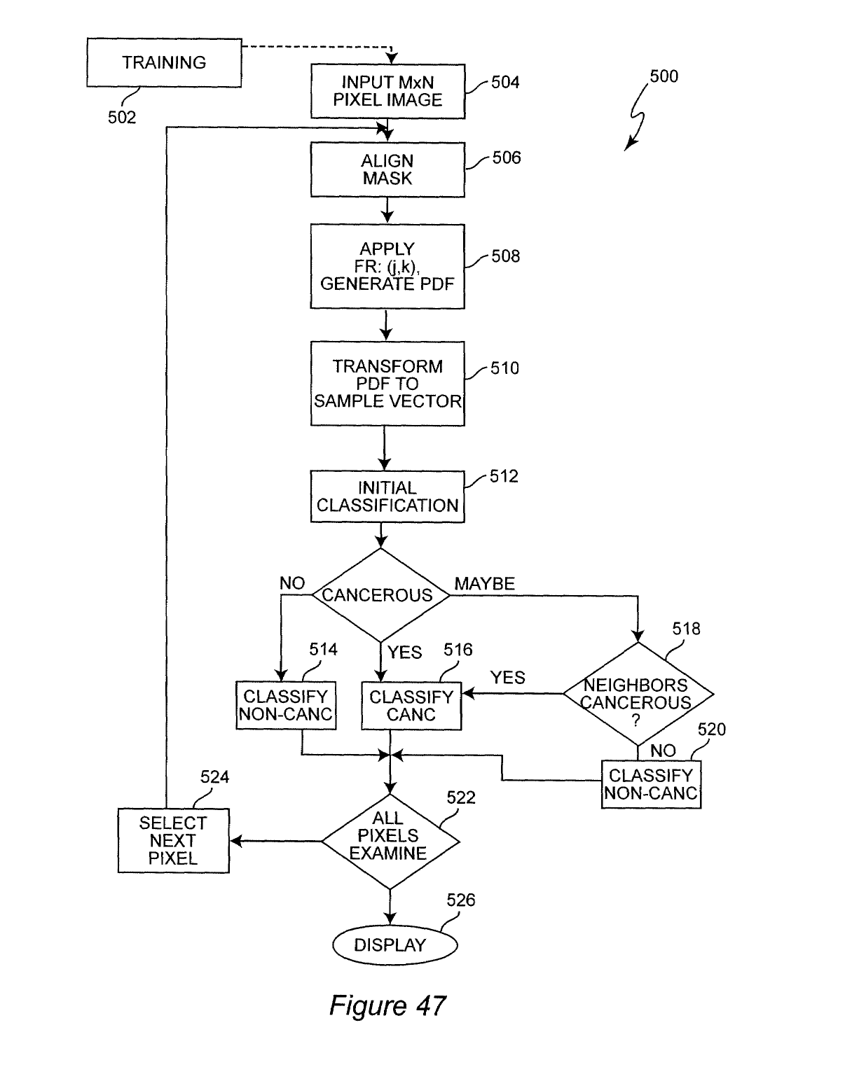

FIG. 47 shows a high level diagram representing operational flow of one example method 500 according to one embodiment.

Referring to FIG. 47, at 502 a training process generates at least one, and preferably at least two R-dimensional classification vectors, each representing a given condition to be detected in subsequent images of tissue. According to one embodiment, two R-dimensional classification vectors are generated such as, for example, Centroid₁ and Centroid₂ described above.

FIG. 48 shows one high level functional block diagram of one example implementation of the training 502. The training 502, the example implementation shown at FIG. 47 and the subsequent functional blocks of FIG. 40 may be performed on the same system, such as the example system represented by FIGS. 1 and 3. Alternatively, the training 502 and the example implementation shown at FIG. 48 may be performed remotely from performing the subsequent blocks of FIG. 47. For example, the training 502 and its example implementation shown at FIG. 48 may be performed on a remote data processing resource similar to that depicted at FIG. 1, and the R-dimensional classification such as, for example, Centroid₁ and Centroid₂ may be transferred to a system as represented by FIGS. 1 and 3 by, for example, the Internet.

Referring to FIG. 48, at 502A a plurality of ultrasound scan first classification training images, collectively labeled Tlmg1, are input, each of the images known to correspond to given condition such as, for example being non-cancerous. The plurality of ultrasound scan first classification training images may be collected from an archive (not shown) or repository (not shown) or from other sources. Also at 502A a plurality ultrasound scan second classification training images, collectively labeled Tlmg2, are input, all of the Tlmg2 images having an area, i.e., at least one particular area of pixels, known as corresponding to another given condition such as, for example being cancerous.

With continuing reference to FIG. 48, at 502B, one of the first classification images is input, and at 502C the sample mask, such as the 11×11 sample mask of FIG. 4, is centered on one of pixels known a-priori as corresponding to tissue having the first subject condition (e.g., being non-cancerous). The centering may be performed manually, by a person of ordinary skill in the art pertinent to the invention.

At 502D all of the basis function FR are applied to the sample mask centered on the selected pixel, to generate a bucket of values for each of the basis functions, corresponding to plurality of pixel pairs scanned by the basis functions. Each of the plurality of values may be formed as a histogram such as, for example, any of the example histograms depicted at FIGS. 5-45. Multiple a-priori known pixels may be selected on each of the first classification images and, for each, the sample mask is centered on the selected pixel, and all of the R basis function FR are applied, to generate the a plurality of R histograms for each. The pixel selection may, for example, be performed by a skilled user by visually inspecting the image on a display, and placing a cursor (not shown) or other pointer on pixels identifiable, with an acceptable certainty, as corresponding to the first subject condition. At 502E, each of the plurality of R histograms is converted to a single value by, for example, the transforming means 210 described above. The 502E conversion may be included in 502D generation of histograms.

With continuing reference to FIG. 48, at 502F the process of 502B selecting first classification images, 502C identifying pixels having the first condition and aligning the sample mask on the selected pixel, 502D generating the plurality of R histograms and 502E generating a training vector is repeated until a plurality of at least G pixels has been analyzed. Then, at 502G the plurality of at least G of the R-dimensional centroid vectors is averaged to generate the first centroid vector Centoid₁.

Referring again to FIG. 48, concurrent with, subsequent to, or prior to generating the first centroid vector Centroid₁, operations identical to blocks 502B through 502G and 502H are performed to generate the second centroid vector Centroid₂. Generating the second centroid vector Centroid₂ is substantially the same as generating the first centroid vector Centroid₁, except that for each input second classification image the sample mask is centered (by a skilled user positioning a mouse or equivalent) over a pixel known to have a second subject condition, e.g., cancer.

Referring again to FIG. 47, after the training 502 generates the first centroid vector Centroid₁ and the second centroid vector Centroid₁, or at some time after the first centroid vector Centroid₁ and the second centroid vector Centroid₂ and provided to the resource on which the FIG. 47 operations are performed, at 504 a new image is input. Next, at 506, a sample mask such as, for example, the FIG. 4 11×11 mask, is centered on a selected pixel. The centering may be automatic, basically moving the sample mask in a raster fashion scan over the entire input image. In such an automatic scanning of the sample mask, each movement may move the sample mask one pixel at a time, to have overlapping sample mask, or may move the sample mask multiple pixels to have partial overlap, or move the mask ½ of he mask width between successive sample masks to have no overlap.

Referring to FIG. 47, at 508 the R basis functions are applied to the mask centered on the subject pixel, to generate R probability density functions PDF, as described above in reference to FIGS. 3 and 4. Next, at 510 each of the R probability density functions is transformed to a single valued representation, such as by calculating the mean for each PDF. Next, at 512, an initial classification is performed which, in the depicted example, classifies the pixel as cancerous, shown as 514, non-cancerous, shown as 516 or possibly cancerous, shown as 518. If the initial classification 512 classifies the pixel as possibly cancerous block 518 stores the pixel until one of two conditions is met. The first condition is that a predetermined number such as, for example, eight of its neighbor pixels are classified as cancerous, in which case the process goes to 516 and classifies the subject pixel as cancerous. The second condition is that it is determined that the predetermined number, e.g., eight of the subject pixel's neighbors cannot be classified as cancerous, in which case the process goes to 520 and classifies the subject pixel as non-cancerous.

With continuing reference to FIG. 47, after each of blocks 514, 516, 518 and 520, the process goes to 522 to determined if all of the pixels in the input image 502, in other words all or substantially all of the N×M pixels, have been examined. If 522 determines that not all pixels have been examined, the process goes to 524, selects another pixel, returns to 506 to center the mask, and repeats the process. If 522 determines that all of the pixels have been examined, the process goes to 526 and displays the results on, for example, the display screen 34.

Referring to FIG. 49, one example display generated at 526 is depicted, with 602 showing a general prostate boundary and 604 showing pixels classified, by one or more of the embodiments, as cancerous.

While certain embodiments and features of the invention have been illustrated and described herein, many modifications, substitutions, changes, and equivalents will occur to those of ordinary skill in the art, and the appended claims cover all such modifications and changes as fall within the spirit of the invention.

We hereby claim:

1. A method for classifying pixels of a pixel image representing a substance into at least two different classes, comprising:
providing a plurality of at least R basis functions;
providing a classification criterion;
receiving an external pixel image;
identifying a subject pixel from said received external pixel image
identifying a spatial window of pixels aligned spatially with the subject pixel;
generating a plurality of R buckets of computed values, each of said buckets based on applying a corresponding one of said R basis functions to pixels within the spatial window;
generating a plurality of R histograms, each of said histograms reflecting an estimated probability density function a corresponding one of said R buckets of values;
transforming said plurality of R histograms into an R-dimensional sample classification vector;
generating a classification data representing one of said two different classes for said subject pixel, based on said R-dimensional sample classification vector and said classification criterion.

2. The method of claim 1, wherein said classification criterion includes an R-dimensional classification vector, and wherein generating a classification data includes transforming said generated plurality of R estimated probability densities into an R-dimensional sample vector.

3. The method of claim 2, wherein said classification criterion further includes a second R-dimensional classification vector, and wherein said generating a classification data includes calculating a first distance from said R-dimensional sample vector to said R dimensional classification vector, calculating a second distance from said R-dimensional sample vector to said second R dimensional classification vector, and a comparative magnitude of said first distance and said second distance.

4. The method of claim 3, wherein said first distance is a first Mahalanobis distance and said second distance is a second Mahalanobis distance.

5. The method of claim 1, wherein said providing a classification criterion includes:
providing a plurality of pixel images, each having at least one pixel having a known classification kind;
selecting a subject pixel from said plurality of pixel images having the known classification kind;
selecting a sample mask of pixels from said pixel image, having the subject pixel and a neighborhood of surrounding pixels;
generating a plurality of R buckets of computed values, each of said buckets based on applying a corresponding one of said R basis functions to pixels within the spatial window;
generating a plurality of R histograms, each of said histograms reflecting an estimated probability density function a corresponding one of said R buckets of values;
transforming said plurality of R histograms into an R-dimensional training classification vector;
selecting another subject pixel from said plurality of pixel images, the pixel having the known classification kind;
repeating said selecting mask, selecting a basis function, generating a plurality of R buckets of values, generating a plurality of R histograms, and transforming, until a plurality of at least G training vectors are generated; and
generating a first centroid vector based on an average of said plurality of at least G training vectors.

6. A method for classifying pixels of a pixel image representing a substance into at least two different classes, comprising providing a plurality of at least R basis functions;
providing a classification criterion;
providing a pixel image;
selecting a subject pixel from the pixel image;
selecting a sample mask of pixels relative to said subject pixel;
selecting a basis function from said at least R basis functions;
generating a bucket of values, by applying said basis function to each of said M pixel pairs to generate a bucket of M values, where said sequence of M pixel pairs is selected based at least on said basis function;
selecting another basis function;
repeating said generating another a bucket of values and said selecting another basis function, to generate another bucket of values, until all of said R basis functions are selected, to generate a plurality of R of said buckets of values;
generating a plurality of R estimated probability densities, each of said densities based on a corresponding one of said R buckets of values; and
generating a classification data for said subject pixel, based on at least one of said generated estimated probability densities and said classification criterion.

7. A machine-readable storage medium to provide instructions, which if executed on the machine performs operations comprising:
providing a plurality of at least R basis functions;
providing a classification criterion;
receiving an external pixel image;
identifying a subject pixel from said received external pixel image
identifying a spatial window of pixels aligned spatially with the subject pixel;
generating a plurality of R buckets of computed values, each of said buckets based on applying a corresponding one of said R basis functions to pixels within the spatial window;
generating a plurality of R histograms, each of said histograms reflecting an estimated probability density function a corresponding one of said R buckets of values;
transforming said plurality of R histograms into an R-dimensional sample classification vector;
generating a classification data for said subject pixel, based on said R-dimensional sample classification vector and said classification criterion.

8. The machine readable storage medium of of claim 7, further providing instructions, which if executed on the machine performs operations comprising said classification criterion including an R-dimensional classification vector, and wherein generating a classification data includes transforming said generated plurality of R estimated probability densities into an R-dimensional sample vector.

9. The machine readable storage medium of claim 8, further providing instructions, which if executed on the machine performs operations comprising: said classification criterion further includes a second R-dimensional classification vector, and wherein said generating a classification data includes calculating a first distance from said R-dimensional sample vector to said R dimensional classification vector, calculating a second distance from said R-dimensional sample vector to said second R dimensional classification vector, and a comparative magnitude of said first distance and said second distance.

10. The machine readable storage medium of claim 8, further providing instructions, which if executed on the machine performs operations comprising: said first distance is a first Mahalanobis distance and said second distance is a second Mahalanobis distance.

11. An ultrasound image recognition system comprising: an ultrasound scanner having an RF echo output, an analog to digital (A/D) frame sampler for receiving the RF echo output, a machine arranged for executing machine-readable instructions, and a machine-readable storage medium to provide instructions, which if executed on the machine, perform operations comprising:
providing a plurality of at least R basis functions;
providing a classification criterion;
receiving an external pixel image;
identifying a subject pixel from said received external pixel image
identifying a spatial window of pixels aligned spatially with the subject pixel;
generating a plurality of R buckets of computed values, each of said buckets based on applying a corresponding one of said R basis functions to pixels within the spatial window;
generating a plurality of R histograms, each of said histograms reflecting an estimated probability density function a corresponding one of said R buckets of values;
transforming said plurality of R histograms into an R-dimensional sample classification vector;
generating a classification data for said subject pixel, based on said R-dimensional sample classification vector and said classification criterion.

12. The method of claim 1, wherein said different classes comprise a first class representing a non-cancerous condition and a second class representing a cancerous condition.

13. The method of claim 5, wherein said pixel image represents an image of a tissue and wherein the different classes comprise a first class representing a non-cancerous condition and a second class representing a cancerous condition.

14. The method of claim 5, wherein said pixel image represents an mage of a prostate and wherein the different classes comprise a first class representing a non-cancerous condition and a second class representing a cancerous condition.

15. The method of claim 6, wherein said pixel image represents an image of a prostate and wherein the different classes comprise a first class representing a non-cancerous condition and a second class representing a cancerous condition.

16. The method of claim 11, wherein said pixel image represents an image of a prostate and wherein the different classes comprise a first class representing a non-cancerous condition and a second class representing a cancerous condition.
